(19) United States
(12) Patent Application Publication
(10) Pub. No.: US 2025/0141718 A1
(43) Pub. Date: May 1, 2025

(54) TRANSMITTER PRE-EQUALIZATION FOR POWER REDUCTION OF XR DEVICE RECEIVER

(71) Applicant: QUALCOMM Incorporated, San Diego, CA (US)

(72) Inventors: Tom BARAK, Rehovot (IL); Assaf TOUBOUL, Netanya (IL); Michael LEVITSKY, Rehovot (IL); Daniel PAZ, Atlit (IL); Alexander SVERDLOV, Rehovot (IL)

(21) Appl. No.: 18/499,915

(22) Filed: Nov. 1, 2023

(51) Int. Cl. H04L 25/03; H04L 5/00; H04W 72/40

(52) U.S. Cl. CPC H04L 25/03006; H04L 5/0051; H04W 72/40

(57) ABSTRACT

A method for wireless communication at a user equipment (UE) and related apparatus are provided. In the method, the UE obtains channel information for a sidelink channel between the UE and a receiving device and performs a pre-equalization process on a signal to be transmitted to the receiving device based on the channel information to obtain a pre-equalized signal. The UE then transmits the pre-equalized signal to the receiving device through the sidelink channel.

### TECHNICAL FIELD

The present disclosure relates generally to communication systems, and more particularly, to equalization for wireless communication with extended reality (XR) device receiver.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to obtain channel information for a sidelink channel between the UE and a receiving device; perform, based on the channel information, a pre-equalization process on a signal to be transmitted to the receiving device to obtain a pre-equalized signal; and transmit, through the sidelink channel, the pre-equalized signal to the receiving device.

In an aspect of the disclosure, a method, a computer-readable medium, and an apparatus are provided for wireless communication at a receiving device. The apparatus may include at least one memory and at least one processor coupled to the at least one memory. Based at least in part on information stored in the at least one memory, the at least one processor, individually or in any combination, may be configured to receive, from a UE, a dedicated reference signal; transmit, to the UE based on the dedicated reference signal, channel information for a sidelink channel between the UE and the receiving device; receive, from the UE, a pre-equalized signal; and process the pre-equalized signal using a simplified receive process. The simplified receive process skips an equalization process for the pre-equalized signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example of extended reality (XR) traffic flows.

FIG. 5 is a diagram illustrating an example of split XR approach.

FIG. 6 is a diagram illustrating a physical (PHY) layer receiver (Rx) architecture.

FIG. 7A is a diagram illustrating an example linear pre-equalization scheme on the Tx side in accordance with various aspects of the present disclosure.

FIG. 7B is a diagram illustrating an example of a non-linear pre-equalization scheme on the Tx side in accordance with various aspects of the present disclosure.

FIG. 8 is a block diagram illustrating an example Tx pre-equalization process in accordance with various aspects of the present disclosure.

FIG. 9 is a diagram illustrating an example transmission of channel information from an XR device to UE in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a receiving device in accordance with various aspects of the present disclosure.

FIG. 14 is a flowchart illustrating methods of wireless communication at a receiving device in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating example XR traffic characteristics and an example of processing at an XR server and an XR device, in accordance with various aspects of the present disclosure.

FIG. 18 is a diagram illustrating a split XR architecture, in accordance with various aspects of the present disclosure.

### DETAILED DESCRIPTION

Extended Reality (XR) is emerging as a technology with potential in applications such as the personal electronics segment. XR technology faces challenges such as the tension between the computational demands of XR applications and the physical constraints, such as weight, power, and head dissipation, of XR devices. XR applications may involve substantial processing power to deliver an optimal user experience, such as high frame rates (e.g., fps≥120 Hz) and superior video formats (e.g., 8K). However, the portability and compact nature of XR devices can prioritize lower weight, power consumption and heat dissipation capabilities. It can be challenging to balance such computational abilities with lower weight, lower power consumption, and reduced heat dissipation. in some aspects, a split XR approach can be used to shift some of the XR-related processing tasks to a companion device to reduce the processing load on the XR devices. A split XR approach, however, may retain many processing components on the XR devices due to various End-to-End (E2E) considerations, such as the photon-to-motion latency requirement and the capacity of the wireless link connecting the XR device and the companion device. As a result, even with the split XR approach, the XR devices' power consumption may be too high for a video quality/user experience benchmark. Example aspects presented herein provide methods and apparatus that allow a reduction, elimination, or removal of the receiver complexity associated with receiver (Rx) equalization, which can be one of the major contributors to modem complexity, by performing a pre-equalization process for the XR device at a user equipment (UE) or a companion device.

Various aspects relate generally to wireless communication. Some aspects more specifically relate to transmitter pre-equalization to enable power reduction and reduce complexity of XR device receivers while maintaining the quality of a user experience. In some examples, the UE (e.g., as a companion device to an XR device) first obtains channel information for a sidelink channel between the UE and a receiving device (an XR device). Then, based on the channel information, the UE performs a pre-equalization process on a signal to be transmitted to the receiving device to obtain a pre-equalized signal, and transmits the pre-equalized signal to the receiving device through the sidelink channel. In some aspects, the channel information may include receive (Rx) channel state information (CSI) associated with the sidelink channel and, in some examples, may further include the channel noise information including a noise covariance matrix associated with the sidelink channel. In some examples, the UE may obtain the channel information directly from the receiving device. In some examples, the UE may obtain the channel information based on a set of receiving samples received from the receiving device.

Particular aspects of the subject matter described in this disclosure can be implemented to realize one or more of the following potential advantages. In some examples, by applying the pre-equalization process at the UE (the companion device) instead of the XR receiving device, the described techniques allow for a reduction of equalization-related complexity at the XR devices, thereby allowing a simpler and more portable/wearable hardware design for the XR devices while maintaining the user experience. In some examples, by adopting the pre-equalization at the transmitter side (e.g., at the companion device side or UE side), the described techniques enable the communication channel between the UE and the XR receiving device to be treated as an additive white Gaussian noise (AWGN) channel, and allow the XR device to skip multiple processing steps that otherwise would have been performed by the XR device, thereby reducing the computation burden of the XR device. In some examples, by providing multiple pre-equalization options on the transmitter side, the described techniques provide the flexibility for choosing the suitable methods according to variable conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

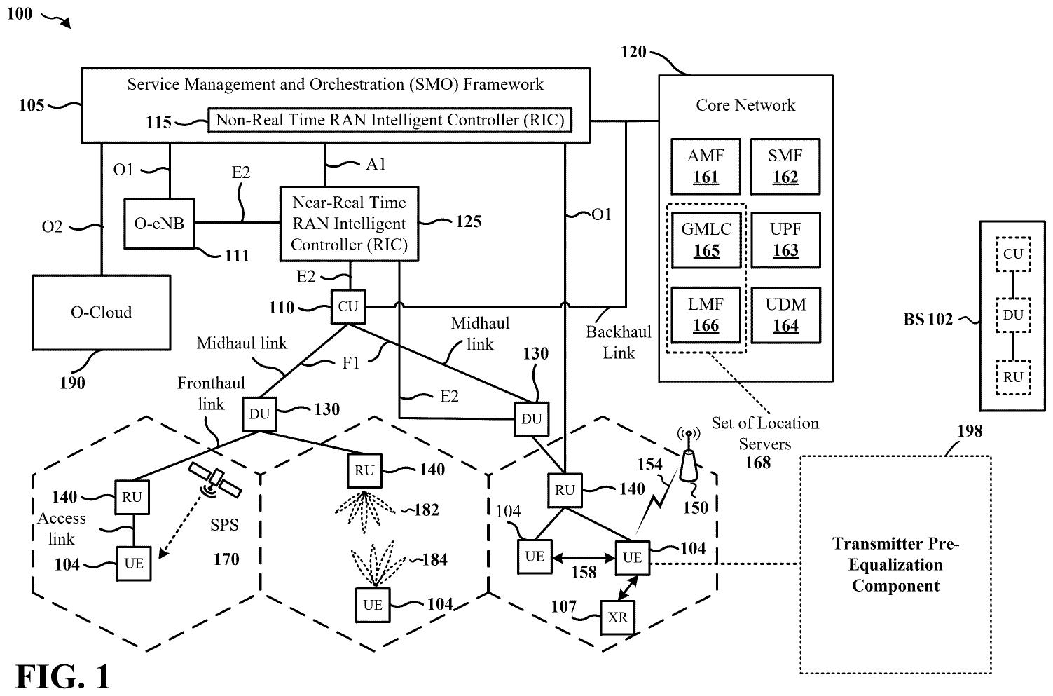

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may support operation as a companion device to one or more XR devices 107. The UE 104 may include a transmitter pre-equalization component 198. The transmitter pre-equalization component 198 may be configured to obtain channel information for a sidelink channel between the UE and a receiving device (e.g., 107); perform, based on the channel information, a pre-equalization process on a signal to be transmitted to the receiving device to obtain a pre-equalized signal; and transmit, through the sidelink channel, the pre-equalized signal to the receiving device. Although the following description may be focused on 5G NR, the concepts described herein may be applicable to other similar areas, such as LTE, LTE-A, CDMA, GSM, and other wireless technologies.

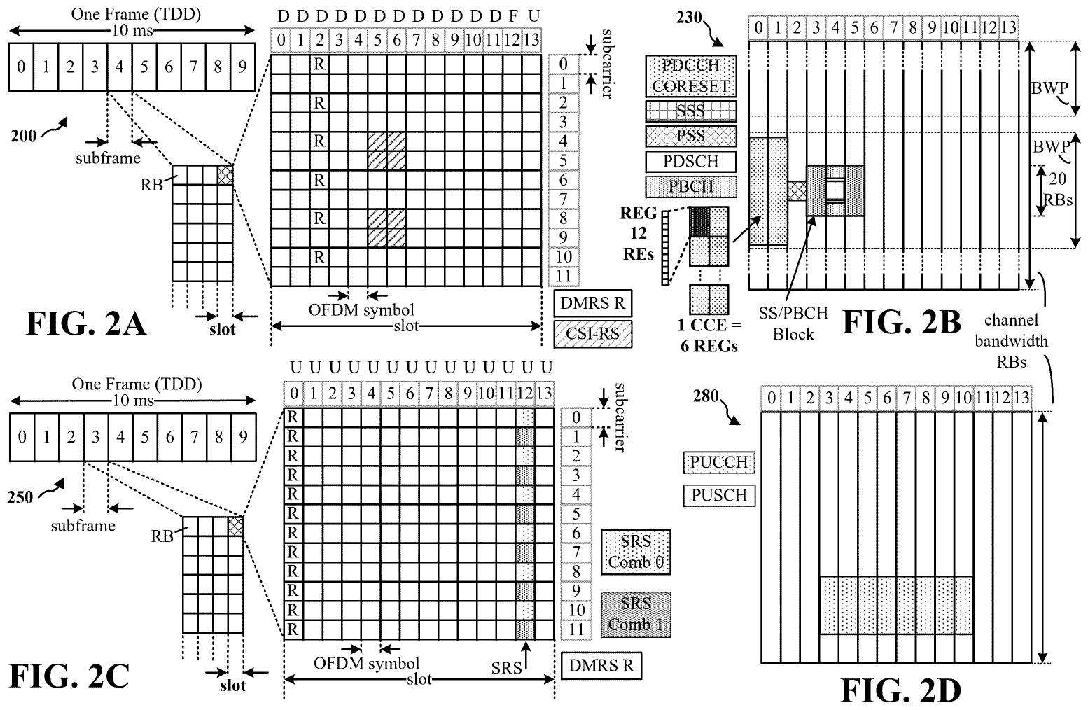

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

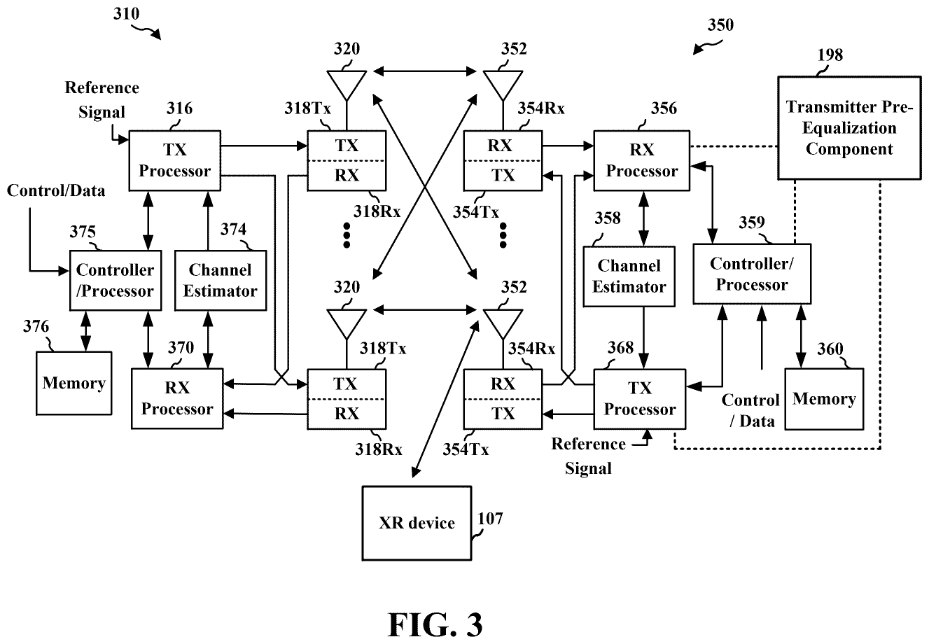

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the transmitter pre-equalization component 198 of FIG. 1, e.g., to equalize a transmission to one or more receiving devices (e.g., 107).

Example aspects presented herein propose techniques for reducing the processing at a receiving device (e.g., which may be referred to as an Rx UE, an XR device, among other examples) by delegating the processing to a companion device (e.g., a UE that assists in the exchange of communication between the network and the receiving device), which enables power saving at the receiving device. Aspects presented herein include performing pre-equalization at the companion Tx device to enable a reduction in receiver complexity at the Rx device.

XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

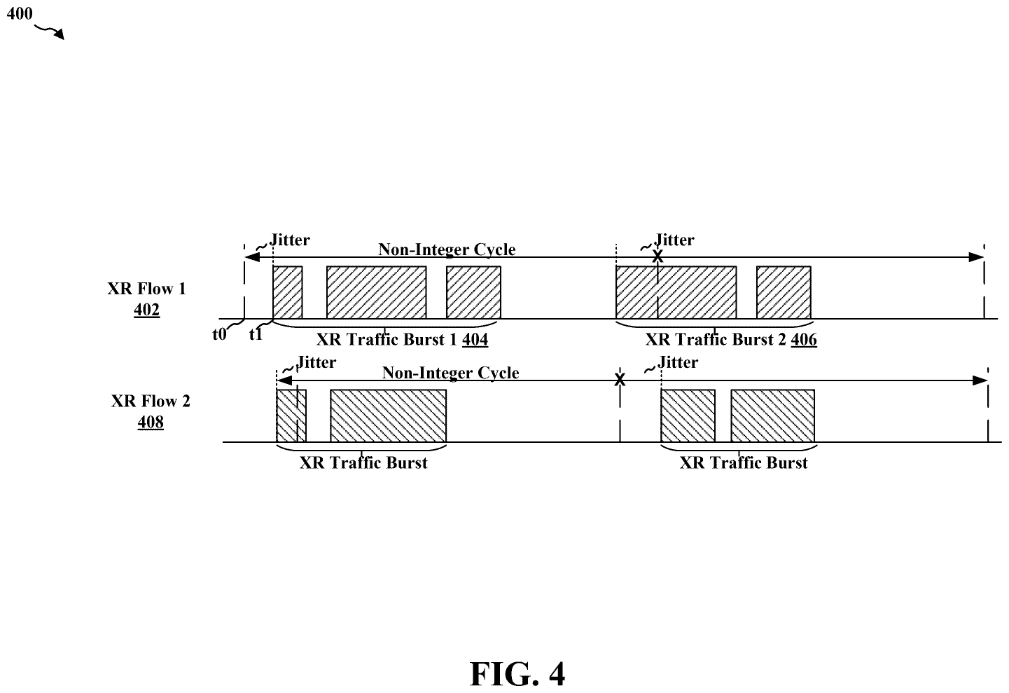

XR traffic may arrive in periodic traffic bursts (“XR traffic bursts”). An XR traffic burst may vary in a number of packets per burst and/or the size of each pack in the burst. The diagram 400 in FIG. 4 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than the time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

XR is emerging as a technology with potential in applications such as the personal electronics segment. XR technology faces challenges such as the tension between the computational demands of XR applications and the physical constraints, such as weight, power, and head dissipation, of XR devices. One challenge for the XR technology is creating a device that is lightweight enough for extended, on-the-go use. For example, an XR device may be comparable in weight to regular glasses, which typically weigh around 30-40 grams. Achieving such a weight involves the inclusion of a lightweight battery. Another challenge is balancing processing complexity and power consumption. As an XR device, such as glasses or goggles, has a smaller surface area compared to other UE, which reduces heat dissipation capabilities. For wearable XR goggles, this might translate to a power consumption restriction of only a few watts.

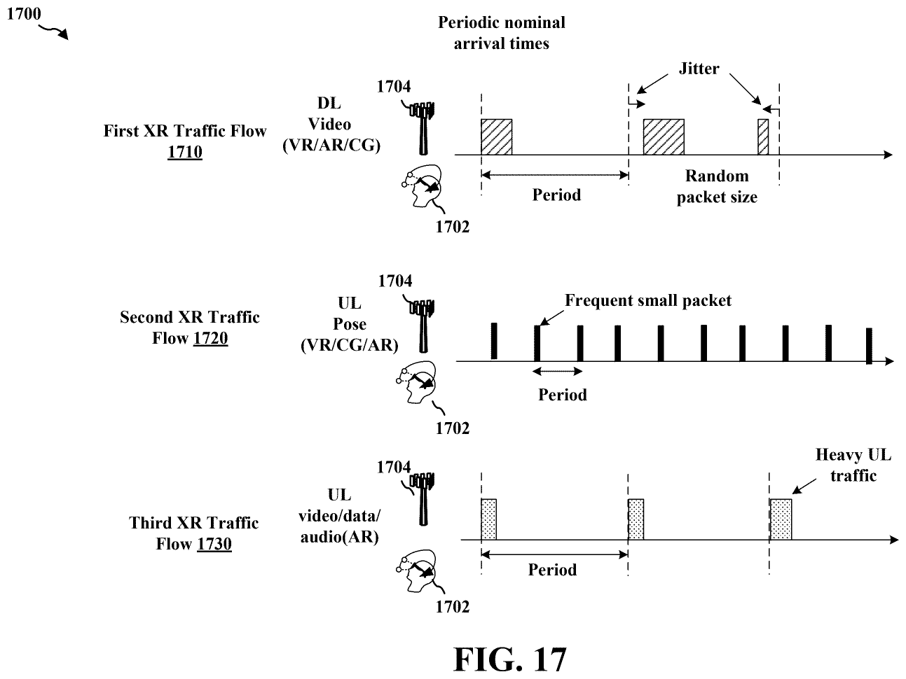

FIG. 17 is a diagram 1700 illustrating example XR traffic characteristics and an example of processing at an XR server and an XR device. As shown in FIG. 17, the diagram 1700 includes a first XR traffic flow 1710 that corresponds to a downlink video from a base station 1702 to a UE 1704. The packets of the first XR traffic flow 1710 may be associated with periodic nominal arrival times, may be associated with jitter, may have random packet sizes, and/or may be associated with a packet delay bound (PDB). The diagram 1700 also includes a second XR traffic flow 1720 and a third XR traffic flow 1730, which correspond to uplink traffic from the UE 1704 to the base station 1702. In the illustrated example of FIG. 17, the second XR traffic flow 1720 corresponds to pose information and may be associated with a frequency of small packets. The third XR traffic flow 1730 of FIG. 17 corresponds to video data or audio data and may be associated with heavy uplink traffic (e.g., larger sized packets).

Such constraints present a challenge for XR devices, especially when considering the intensive processing of many XR applications. Standalone XR products may have flexibility with the “on-the-go” requirements and may be suitable for specific, static, short-term use scenarios, assuming a higher form factor head-mounted device (HMD) usage.

A high-form-factor HMD may be less convenient for some applications. Aspects presented herein enable a shift of at least a portion of the XR processing to a separate companion device. A split XR approach, may alleviate some of the burdens on the XR device. The split XR approach offloads rendering-related processing to a companion device. However, several processing components may remain on the XR device due to various end-to-end (E2E) considerations, including photon-to-motion latency requirements and the capacity of the wireless link between the XR and the companion devices. The power consumption on the XR device may remain high even for a less demanding video quality or user experience benchmark and a less demanding application.

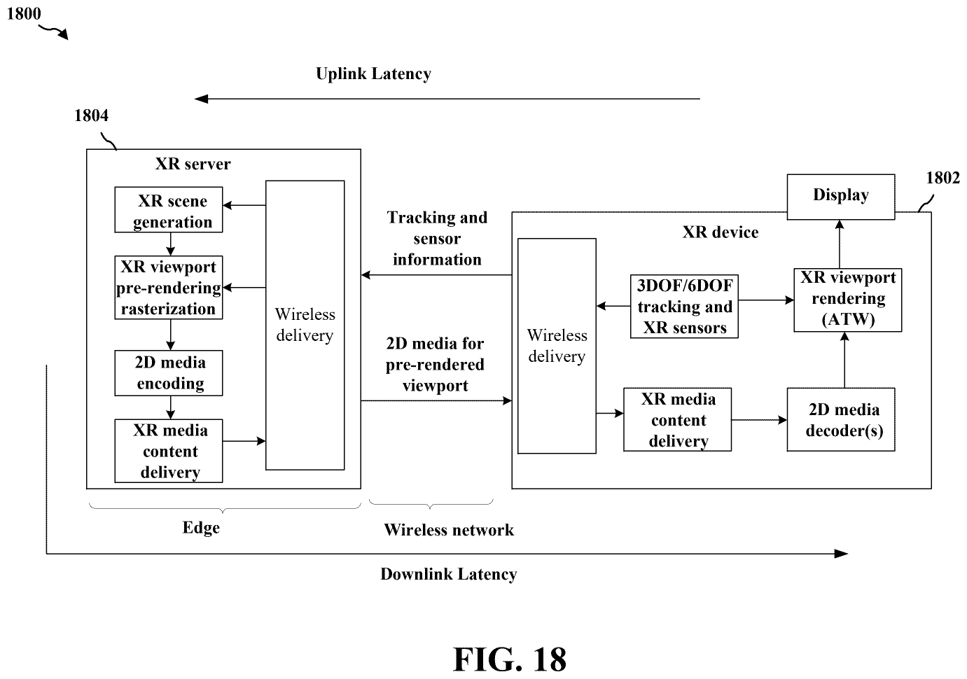

FIG. 18 is a diagram 1800 illustrating a split XR architecture, as presented herein. In the illustrated example of FIG. 18, the diagram 1800 includes an XR device 1802 and an XR server 1804. In the illustrated example of FIG. 18, user pose information and input information is transmitted by the XR device 1802 and received by the XR server 1804. The XR server 1804 may then transmit rendered video frame(s) that are received by the XR device 1802 for display by the XR device 1802. User pose information and controller transmission rates may be the same as the video frame rate, such as 90 [Hz]. The XR server 1804 may render a video frame based on the latest (or most recent) user pose information available to the XR server 1804. To provide a good user experience, the delay from user motion (e.g., at the XR device 1802) to server render (e.g., at the XR server 1804) to the device display (e.g., at the XR device 1802) may be minimized. The delay may also be referred to as a user Motion To server Render To device display (Photon) (M2R2P) delay. In some aspects, the M2R2P delay may vary based on the RTT and the multimedia processing times at the client (e.g., the XR device 1802) and the server (e.g., the XR server 1804). Additionally, the RTT may be based on the uplink latency and the downlink latency.

Aspects presented further address the inherent technological limitations of XR while improving support for more demanding premium applications (e.g., applications with fps≥120 Hz and video formats≥8 k).

The split XR approach may assume long-range communication links over a licensed spectrum with tight scheduling and staggering among different served XR users. To manage capacity allocated per user, XR devices may employ some sensor processing locally to reduce the uplink (UL) data volume (e.g., for 6 degrees of freedom (6DoF) tracking and eye tracking for field-of-view derivation). Additional sensor or camera data from the XR (on the uplink) and the video rendered for the XR device (on the downlink) may be compressed with a high compression rate to fit within the link capacity for each user. Sensor's data pre-processing on the XR device and the video compression with high compression rates (e.g., the High profile of H.264), can be computationally intensive, especially for the encoder side, and both the transmission (Tx) and reception (Rx) pathways for video processing necessities extensive double data rate (DDR) usage, which is a heavy power consumer. Additionally, due to the photon-to-motion latency requirements and the latencies associated with base station-based split processes, the Rx side processing on XR devices may include asynchronous time wrapping (ATW) to ensure last-moment image alignment with the most recent pose information. As a result, the power consumption numbers for the split XR approach, which are focused on downlink-related XR processing, may surpass the desired levels for lightweight small form factor XR wearable smart glasses (with a range of approximately 1.5-3 watts).

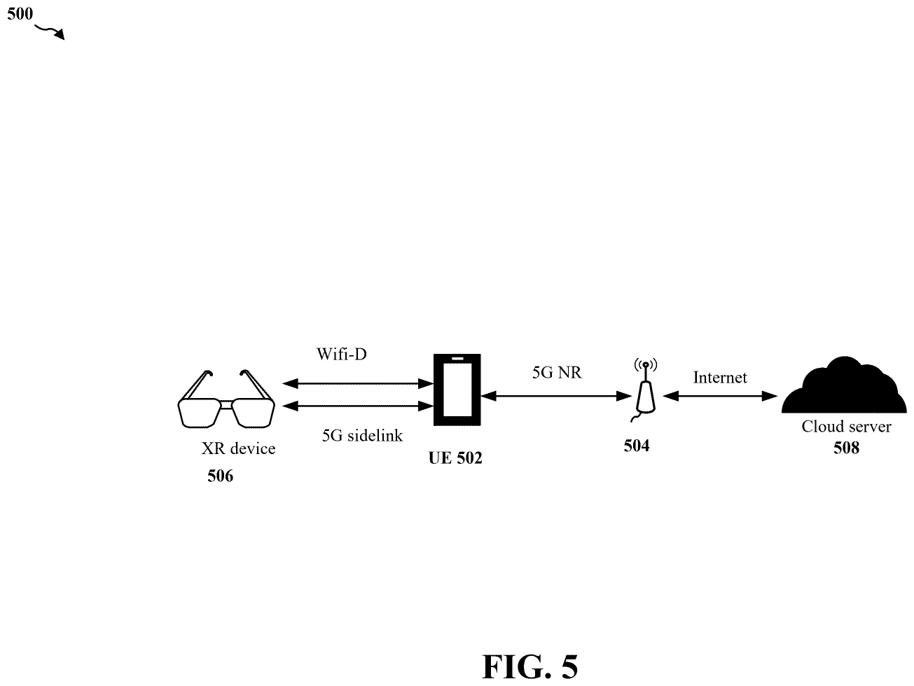

Other split XR approaches may involve offloading processing to a relatively close companion device (e.g., UE) or splitting the processing between the XR device, the companion UE, and the base station (e.g., a gNB). From the XR device's perspective, this split may be based on a similar processing load and locally covered functionality on the XR device side. With a local, short-range communication link with the associated UE (either through 5G NR sidelink or WiFi), this approach serves to reduce modem-related power consumption. FIG. 5 is a diagram 500 illustrating an example of a split XR approach. In FIG. 5, the XR device 506 (which may be, for example, augmented reality (AR) glasses) may offload the process to various components connected with it, such as the UE 502, base station 504, and a cloud server 508.

Another split XR approach may involve processing offloading from the XR device to its companion device (e.g., a companion UE or the combination of UE and base station). Such an approach may target transforming the XR device into a primary input/output (I/O) unit, which may share the local sensor information with the UE without pre-processing and may receive rendered video from the UE to be displayed directly without post-processing. This approach may reduce the XR device's power consumption (e.g., by approximately 50%) compared to a split XR approach. As an example, by transforming XR glasses closer to a pure I/O device, the complexity associated with both transmission (Tx) and reception (Rx) in the XR device can be transferred substantially to the companion device or UE. This target may be followed across all the functional components of the XR device, including the PHY/modem-related complexity.

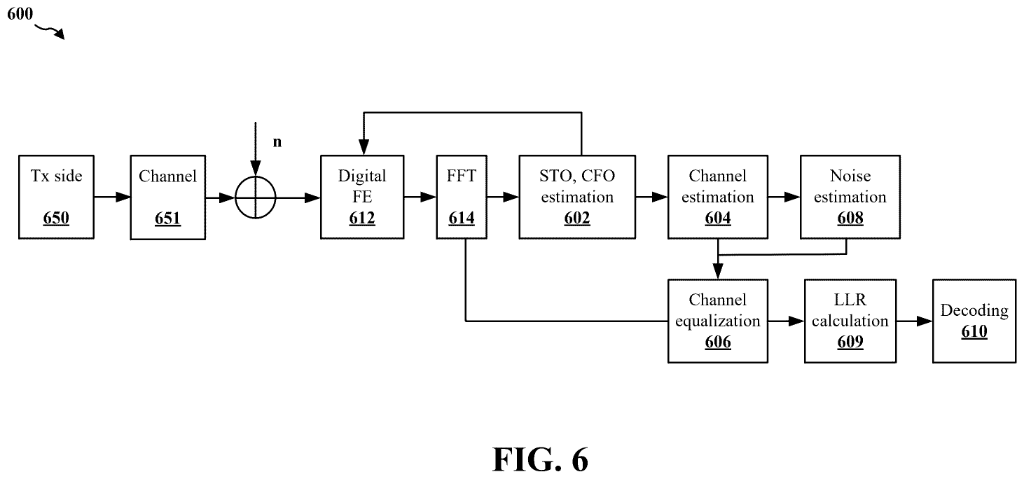

Much of the modem complexity is associated with Rx-side processing. A low complexity, low power, and low latency XR sidelink design and waveform may be achieved via complexity reduction approaches for different PHY Rx components. FIG. 6 is a diagram 600 illustrating an example physical (PHY) layer Rx architecture. In FIG. 6, the use of “continuous” uplink (UL) and downlink (DL) channels, leveraging sub-band full duplex (SBFD) or frequency division duplexing (FDD), may be assumed to allow PHY approach, where most of the Rx baseband (BB) processing-related complexity may be shifted to the transmission (Tx) side for dramatic XR device complexity and power consumption reduction. For example, in FIG. 6, one or more RX PHY modules may be degenerated or effectively shifted to the Tx side from the XR Rx side. This shift may allow the XR device to undergo minimal processing, leading to a substantial reduction in Rx modem complexity and power consumption. FIG. 6 illustrates a transmitter 650 that transmits a signal to a receiver on a channel 651, and illustrates example aspects of processing that occur at a receiver in order to receive the signal from transmitter. For example, a digital front end (FE) 612 and Fast Fourier Transform (FFT) 614 processing are performed. For example, in FIG. 6, the loops management for the carrier frequency offset (CFO) and symbol timing offset (STO) estimation and synchronization (at 602) for XR may be performed on the UE side, with the correction updates indicated by the UE to the paired XR device to be applied locally. The processing for channel estimation 604 may be distributed between the Rx and Tx sides for non-reciprocal channels (e.g., FDD/SBFD) with only “channel sampling” on the Rx side (which may be indicated to the Tx side). For channel equalization 606, the space-frequency equalization may be moved to the Tx side (with non-linear or linear Tx pre-equalization). For noise estimation 608, with the channel equalization 606 being shifted to the Tx side, no local noise/interference filtering/interference rejection combining (IRC) may be employed on the Rx side, and log-likelihood ratio (LLR) scaling reference signal (RS) for peak-to-peak error vector magnitude (pp EVM) measurement may be used to dynamically trace interference for decoding. For example, FIG. 6 illustrates an example LLR calculation at 609. The STO, CFO estimation (e.g., 602) and channel equalization can consume a significant amount of power at the receiver. With the complexity reduction in one or more of STO, CFO estimation 602, channel estimation 604, channel equalization 606, or noise estimation 608, a lower complexity decoding 610 may be employed on the Rx side, as presented herein.

In FIG. 6, some of the PHY module shifts may assume a “quasi-continuous” channel state information (CSI) knowledge of the channel. For scenarios that lack channel reciprocity, this can be realized if either SBFD or FDD transmission techniques are incorporated into the XR sidelink.

Example aspects presented herein provide methods and apparatus that allow a reduction, elimination, or removal of receiver complexity associated with Rx equalization, which is one of the key complexity contributors at the modem, from the XR device. This complexity reduction on the XR device modem side may be achieved by applying Tx pre-equalizer on the UE or companion device side instead of the Rx equalization on the XR device side (i.e., shifting the equalization complexity from the receiver to the transmitter).

The use of space-frequency Tx pre-equalization allows effective channel inversion from the transmission side. As a result, the communication channel, as seen from the receiver's perspective, becomes a nearly additive white Gaussian noise (AWGN) channel with predefined orthogonal multiple-input multiple-output (MIMO) layers (which may be assumed in advanced by definition when Tx pre-equalization is employed). Consequently, the receiver, or the XR device, may be simplified because several resource-intensive processing stages may be skipped. In some aspects, the use of space-frequency Tx pre-equalization is applicable (with some adjustments) with the orthogonal frequency division multiplexing (OFDM) waveform, and the channel information or CSI for the UE to XR link may be known to the transmitter side (UE) for channel inversion/pre-equalization and inter-layer interference pre-cancellation.

The use of a Tx pre-equalizer helps to reduce the equalization complexity on the Rx side by applying a signal pre-equalization at the transmitter device. In some aspects, there may be several pre-equalization as alternative options that may be employed in the Tx pre-equalizer.

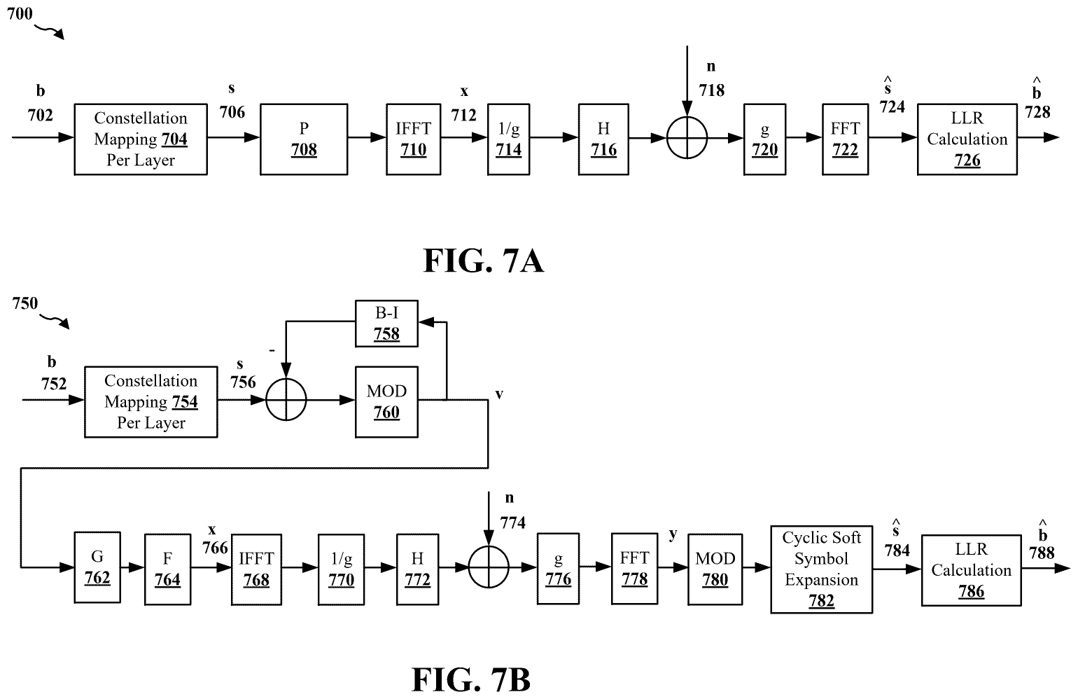

In some examples, the Tx pre-equalizer may be a linear Tx pre-equalizer, which may use Tx zero forcing (ZF) and Tx minimum mean square error (MMSE) pre-equalization. The ZF pre-equalization method may nullify the channel and interference effects by applying a channel inversion. On the other hand, the MMSE pre-equalization minimizes the mean-square error between the transmitted and received signals, while optimally preserving the trade-off between the residual channel distortion and noise enhancement. Hence, the MMSE pre-equalization may offer better results than the ZF pre-equalization. FIG. 7A is a diagram 700 illustrating an example linear pre-equalization scheme on the Tx side in accordance with various aspects of the present disclosure. In FIG. 7A, on the Tx side, the input data b 702, which may be a source bit stream, may go the constellation mapping 704 per layer to obtain the source symbols s 706. The source symbols s 706 may go through the Tx pre-equalization P 708, and inverse Fast Fourier Transform (IFFT) 710. The resulting pre-equalized signal x 712 may go through the 1/g 714 and the channel transmission H 716 to be transmitted to the receiver side. The noise n 718 may be added during the transmission to the receiver side. In FIG. 7A, as shown at 714 and 716, g represents the TX scaling factor, which may comply with the total or per antenna Tx power restriction, and H represents the channel. On the receiver side, the received signal may go through g 720, the FFT 722 to obtain the estimated symbols ŝ 724, and the estimated bits \hat{b} 728 (decoder output) may be obtained after the LLR calculation 726. The example in FIG. 7A may be applicable for OFDM waveform, and similar schemes can be defined for other waveforms, such as DFT-spread orthogonal frequency division multiplexing (DFT-S-OFDM) waveform (and for true single carrier).

In some examples, the Tx pre-equalizer may be a non-linear pre-equalizer, which may use Tomlinson-Harashima Precoder ZF (THP-ZF) pre-equalization or THP-MMSE pre-equalization. The THP method is a practical and approximated implementation of the “dirty paper coding” that is optimized to achieve the maximum capacity over the channel. Its principle involves a known interference (spatial inter-layer or multipath related Inter-Symbol Interference (ISI)) pre-cancellation on the Tx side using a feedback filter, followed by a feedforward filter for channel pre-equalization. The possible power boosting that may be caused by the feedback filter may be limited with a modulo operator applied on the Tx side, with a corresponding module on the Rx side. FIG. 7B is a diagram 750 illustrating an example of a non-linear pre-equalization scheme on the Tx side in accordance with various aspects of the present disclosure. In FIG. 7B, the input data b 752, which may be a source bit stream, may go through the constellation mapping 754 per layer to obtain the source symbols s 756. The source symbols s 756 may go through a feedback loop composed of the cross-layer interference cancellation (B-I 758) and the modulo operation (MOD 760), per layer scaling (G 762), and feedforward equalization (F 764) to obtain the pre-equalized signal x 766. The pre-equalized signal x 766 may go through the IFFT 768, the 1/g 770, and the channel transmission H 772 to be transmitted to the receiver side. The noise n 774 may be added during the transmission to the receiver side. In FIG. 7B, g represents the TX scaling factor, which may comply with the total or per antenna Tx power restriction, and H, as shown at 772, represents the channel. On the receiver side, the received signal may go through g 776, the FFT 778, and the modulo operation (MOD 780) to obtain the estimated symbols ŝ 784. In the scenarios where the THP-MMSE pre-equalization is employed, cyclic soft symbol expansion 782 may be used after the modulo operation (MOD 780) to mitigate modulo-related loss on the Rx side. The estimated bits \hat{b} 788 (decoder output) may be obtained after the LLR calculation 786. The example in FIG. 7B may be applicable for OFDM waveform, and similar schemes can be defined for other waveforms, such as DFT-S-OFDM waveform (and for true single carrier).

Two transmission (Tx) scaling options may be used to preserve the allowed transmission power. The first option involves total power scaling across all antennas, while the second option involves per-antenna maximum power restriction or scaling. The Tx scaling may lead to Rx noise enhancement, and a Tx pre-equalization method associated with less Tx scaling can result in a higher overall signal-to-noise ratio (SNR). Due to the modulo operation, the THP pre-equalization may not be affected by any Tx power increase, and therefore has a better inter-layer interference mitigation ability as being used as a successive interference cancellation (SIC) pre-equalizer on the Tx side, although it may suffer from a modulo loss under low SNR conditions.

In some aspects, various types of Tx pre-equalization not only necessitate the knowledge of channel state information (CSI), but also stationary noise statistics information on the Rx side, including both thermal noise statistics and stationary interference characteristics, which may be represented by the noise covariance matrix (Rₙₙ).

In some aspects, the Tx pre-equalization may be employed conditioned to the corresponding capabilities on the paired UE and XR device sides. For example, the UE may support Tx pre-equalization and provide some indications or side information to the paired XR device to support simplified Rx procedures on the XR device side.

On the other hand, the XR device may provide the paired UE with all necessary indications to enable Tx pre-equalization, which may include full or partial CSI side information and Rx side Run measurements. Moreover, the XR device may be capable of receiving certain side information or indications from the UE (or Tx side) for Rx side processing with Tx pre-equalization employed. Examples of the side information or indications may include Rx sample scaling, spatial layers unbiasing, and LLR scaling. The XR device may combine the side information or indications with local measurements prior to utilizing them in a simplified Rx processing flow. For example, LLR scaling may be performed based on local Rx side noise and interference measurements and residual equalization and channel estimation error components that can be evaluated on the Tx side and indicated to the Rx side for improved performance.

In some aspects, applying a Tx pre-equalization scheme on the UE side allows a significant reduction in complexity on the XR device side (e.g., the complexity of the Rx modem) while approximately the same performance as with that achieved with a regular Rx side equalization may be preserved. In some examples, Tx pre-equalization may lead to performance improvements, although the support of Tx pre-equalization may necessitate low latency signaling between the Tx and Rx sides.

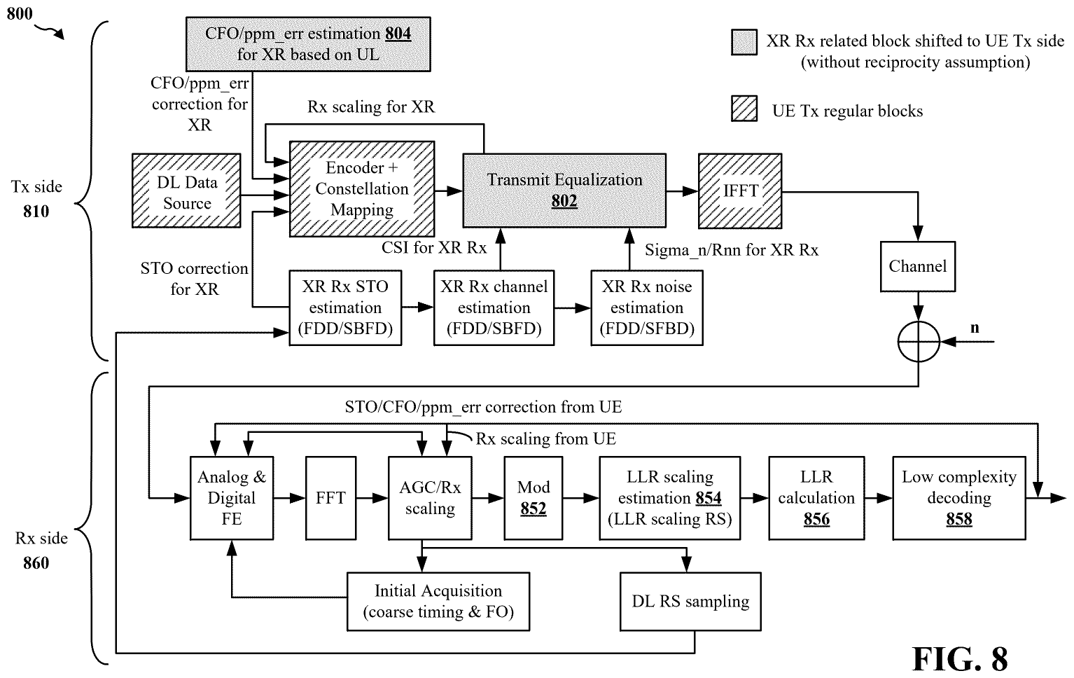

FIG. 8 is a block diagram 800 illustrating an example Tx pre-equalization process in accordance with various aspects of the present disclosure. As shown in FIG. 8, the equalization 802 and CFO estimation 804 may be the processes that can be shifted from the Rx side 860 to the Tx side 810. By shifting the equalization 802 to the Tx side 810, Rx side complexity may be reduced. When performing Tx side equalization, the Tx power constraint (e.g., total power constraint for all antennas, per-antenna power constraint, or the power constraint for ultra-wideband (UWB) by the Federal Communications Commission (FCC)) may be taken into consideration, and Rx CSI information may be known to the Tx side. On the Rx side 860, the modulo operation (Mod 852) may be added when a THP pre-equalization scheme, such as THP-ZF pre-equalization or THP-MMSE pre-equalization, is used. The LLR scaling estimation 854 may improve the robustness to interference and CSI aging with small (e.g., <1.5%) overhead. In some examples, when the modulo operation (Mod 852) is used, the LLR calculation 856 may be enhanced with cyclic constellation expansion, such as that in 782, to mitigate modulo-related loss on the Rx side. With the equalization 802 being shifted to the Tx side 810, a low complexity decoding 858 may be used at the Rx side 860 to decode the received signal.

In some aspects, to support the Tx pre-equalization, the XR device may report its capabilities in order to receive and process transmissions with Tx side pre-equalization at the UE or companion device.

For example, if both the XR and the UE have the capacity to support Tx pre-equalization and related procedures, the selected Tx pre-equalization method and transmission scheme (Tx or Rx equalization) may be indicated from the UE (which may act as the transmitter device for XR sidelink) to the XR device. Pre-equalization may refer to equalization that is performed at the transmitter before transmitting to the receiver in order to reduce or avoid an equalization processing at the receiver. After capabilities negotiation, the transmission scheme or Tx pre-equalization method may be indicated by the UE to the XR device via RRC configuration before the transmission of application data with the pre-equalization starts.

Tx pre-equalization may be used after the Rx CSI information is received at the Tx side, e.g., after the companion device receives the CSI from the XR device. In situations where the updated CSI information is unavailable from the receiving device, the transmitting device might decide to fall back to an equalization at the receiver (e.g., without pre-equalization at the transmitter) until an updated CSI side information is obtained, ensuring a robust communication link. To allow maximum flexibility, robustness and dynamic adaptation, the employed transmission scheme or the choice between Tx or Rx side equalization may be dynamically indicated based on a synchronized layer 1 (L1) or layer 2 (L2) signaling, using DCI, media access control (MAC)-control element (MAC-CE), or some other control signaling mechanisms.

CSI acquisition for Tx pre-equalization may be performed differently according to channel reciprocity. In the absence of channel reciprocity, such as with SBFD or FDD, the XR device may signal CSI related information (or partial CSI) to the UE (e.g., as the companion device). In some examples, the signaling of CSI related information may be performed in a more efficient way that enables a lower complexity at the XR device by signaling raw Rx signal samples or channel samples to the UE or companion device. The UE may then perform the Rx side channel and noise estimation procedures locally (e.g., at the UE) on the raw samples, thereby reducing complexity for the XR device to give the UE an understanding of the CSI.

In some aspects, several Tx pre-equalization techniques, such as those based on the MMSE criterion, may be based on the Tx/UE side having knowledge of Rx noise statistics (e.g., Rₙₙ) from the XR device. In some examples, the Rx side noise information may be derived based on indicated Rx side raw data or channel samples indicated by the Rx side to the Tx side. In these cases, the XR device may not provide additional noise-related indication.

In some aspects, the TX pre-equalization related procedures may be applied in scenarios where there is not channel reciprocity (SBFD/FDD transmission scheme). In this scenario, an uplink (UL) channel estimation may not be used to obtain CSI for Tx pre-equalization, as the UL and downlink (DL) channels may operate on different bands or frequency ranges and there may not be channel reciprocity. In such situations, CSI side information or indications may be transmitted from the XR device to the UE.

The CSI side information may be transmitted in various ways. In some examples, the transmission can be implicit, where the XR device may indicate or report raw data or channel samples, referred to as the “sampled channel,” to the UE. In this scenario, the UE may evaluate the Rx side noise statistics, or Rₙₙ, based on the “Rx sampled channel” indication (channel and noise may be separated along the channel estimation procedures on the UE side). In some examples, the transmission may be explicit, where the XR device may indicate the estimated CSI directly to the UE. To facilitate this, the XR device may perform local channel estimations based on a dedicated pilot (e.g., reference signal) in the DL, and the XR device may signal the obtained channel estimations to the UE. In this scenario, the Rx side noise statistics, or Rₙₙ, may also be measured locally by the XR device and subsequently indicated to the UE. For both implicit and explicit transmission of the CSI side information, there may be no reciprocity between the Tx and Rx noise characteristics, and the Rx side noise information (Rₙₙ) may be indicated from the XR to the UE.

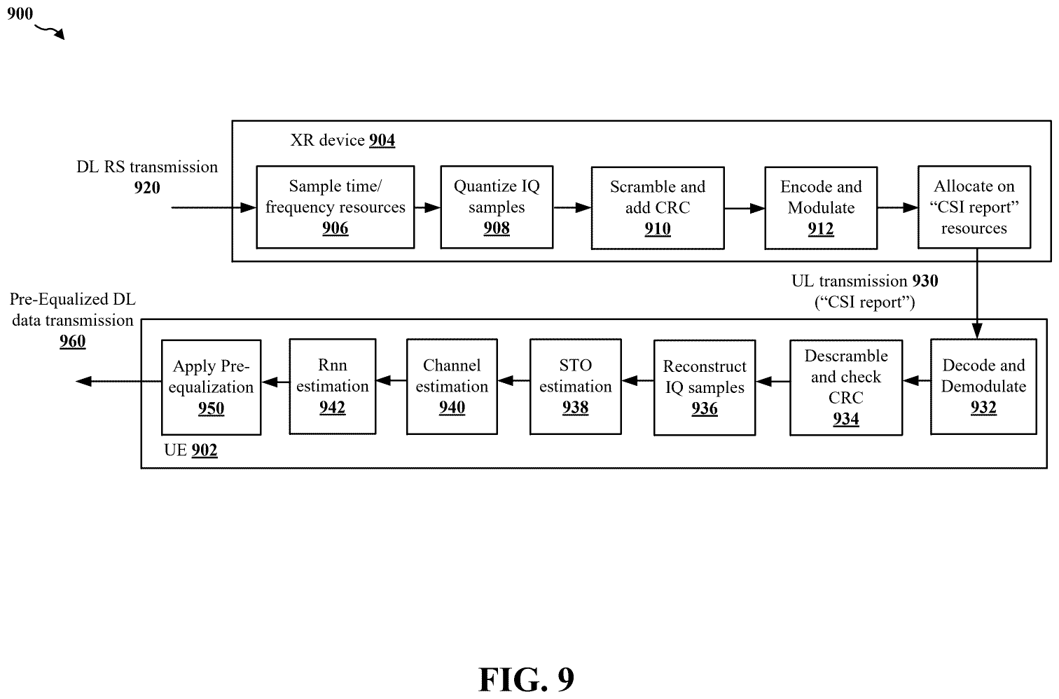

FIG. 9 is a diagram 900 illustrating an example transmission of channel information from an XR device to UE in accordance with various aspects of the present disclosure. In FIG. 9, the XR device 904 receives a DL RS transmission 920 from, for example, the UE 902. The XR device 904 may perform various processes based on the DL RS, including DL RS sampling (e.g., at 906) and quantization (e.g., at 908), scramble and CRC insertion (e.g., at 910), encoding and modulation (e.g., at 912). Then, the XR device 904 may transmit the processed data to the UE 902 via UL transmission 930. On the UE side, the UE 902 may process the received data from the XR device 904. The process may include, decode and demodulation (e.g., at 932), descrambling the CRC check (e.g., at 934), IQ sample reconstruction (e.g., at 936). Based on the received data, the UE 902 may perform various evaluations or estimations related to the pre-equalization process, including STO estimation (e.g., at 938), channel estimation (e.g., at 940), noise estimation such as Run estimation (e.g., at 942). Based on the evaluation and estimation, the UE 902 may apply a pre-equalization process (at 950) on a signal to be transmitted to the XR device 904, and transmit the pre-equalized signal to the XR device 904 (e.g., at 960). As used herein, the term “DL” or “UL” is used to describe communication between UE and the associated XR device, these terms may indicate the direction of the communication and do not specify the characteristics of the channel. For example, “DL” may indicate a transmission from the UE to the XR device, and “UL” may indicate a transmission from the XR device to the UE. The communication between the UE and the XR device may be through a sidelink channel.

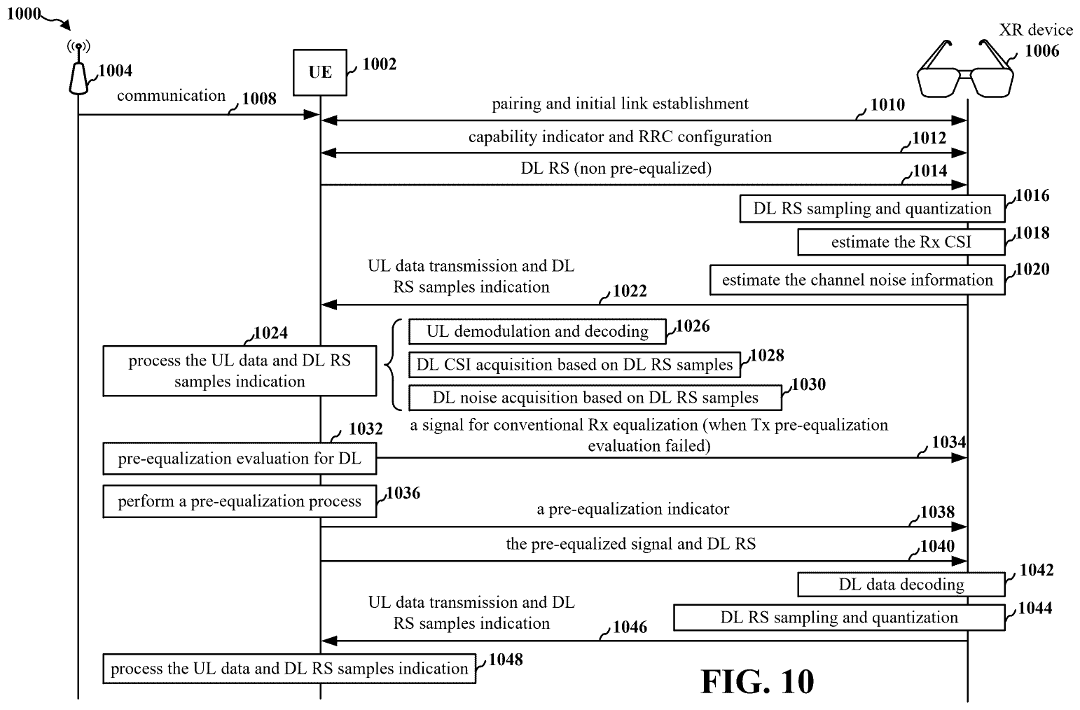

FIG. 10 is a call flow diagram 1000 illustrating a method of wireless communication in accordance with various aspects of this present disclosure. Various aspects are described in connection with a UE 1002, a base station 1004, and a receiving device 1006, which may be an XR device. The aspects may performed by the base station 1004 in FIG. 10 may be performed by a base station in aggregation and/or by one or more components of a base station 1004 (e.g., such as a CU 110, a DU 130, and/or an RU 140). In some aspects, the base station 1004 or one or more components of the base station 1004 may be referred to as a network node or a network entity. Although aspects are described herein (e.g., in FIG. 10 as well as FIGS. 5-9) for an example XR device as the receiving device 1006, the aspects may be performed by any receiver to enable a reduction in complexity at the receiver. Although aspects are described herein (e.g., in FIG. 10 as well as FIGS. 5-9) for a UE 1002 that assists in exchanging communication between a network and a receiving device, the aspects may be performed by another device acting as a transmitter to the receiving device, and the UE 1002 may be referred to as a companion device or transmitter device.

As shown in FIG. 10, at 1008, the UE may receive communication from the base station 1004, and may generate a pre-equalized signal based on the communication to provide to the XR device. A pre-equalized signal from the UE 1002 to the receiving device 1006 may include the communication from the base station 1004 for the receiving device 1006, for example.

At 1010, the UE 1002 may perform pairing and establish an initial link with the receiving device 1006. The link (or channel) between the UE 1002 and the receiving device 1006 may be, for example, a sidelink channel.

At 1012, the UE 1002 may communicate with the receiving device 1006 a capability indication. The capability indication may indicate a support of the pre-equalization process. In some examples, the UE 1002 may transmit to the receiving device 1006 the capability indication indicating the support of the pre-equalization process on the UE 1002. In some examples, the UE 1002 may receive from the receiving device 1006 the capability indication indicating the support of the pre-equalization process on the receiving device 1006. The UE 1002 and the receiving device 1006 may communicate RRC configuration.

At 1014, the UE 1002 may transmit a DL reference signal (RS) to the receiving device. The DL RS may not be pre-equalized at the UE 1002.

At 1016, upon receiving the RS, the receiving device 1006 may process the received RS. For example, the receiving device 1006 may, at 1006, perform sampling and quantization on the DL RS.

In some examples, at 1018, the receiving device 1006 may estimate the Rx CSI for the channel between the UE 1002 and the receiving device 1006 based on the received DL RS.

In some examples, at 1020, the receiving device 1006 may estimate the channel noise information, such as the noise covariance matrix, for the channel between the UE 1002 and the receiving device 1006.

At 1022, the receiving device 1006 may transmit the UL data and DL RS samples indication to the UE 1002. The UL data may include, for example, the channel information for the channel between the UE 1002 and the receiving device 1006. As an example, the channel information may include the Rx CSI estimated at 1018 and the channel noise information estimated at 1020. The DL RS sampling indication may include a set of samples based on the DL RS.

At 1024, the UE 1002 may process the received UL data and DL RS samples indication. For example, at 1026, the UE 1002 may perform UL demodulation and decoding on the received UL data. At 1028, the UE may obtain the DL CSI based on the DL RS samples. At 1030 the UE 1002 may obtain the DL noise based on the DL RS samples.

At 1032, based on the channel information, such as the CSI (obtained at 1028) or channel noise (obtained at 1030), the UE 1002 may evaluate whether it is feasible to perform pre-equalization at the UE side (Tx side).

If the UE 1002 determines that it is not feasible to perform pre-equalization at the UE side (Tx side), the UE 1002 may, at 1034, transmit the signal without pre-equalization on the UE side. In that case, the receiving device 1006 may perform a regular equalization process on the received signal on the receiver side.

If the UE 1002 determines that it is feasible to perform pre-equalization at the UE side (Tx side), the UE 1002 may perform a pre-equalization process on a signal to be transmitted to the receiving device 1006.

At 1038, the UE 1002 may transmit a pre-equalization indicator to the receiving device 1006. The pre-equalization indicator may indicate the receiving device 1006 to use a simplified receive process (e.g., skip the equalization process) for the pre-equalized signal received at 1038. In some examples, the pre-equalization indicator may further indicate a pre-equalization method (e.g., ZF, ZF-MMSE, THP-ZF, or THP-MMSE) used in the pre-equalization process at 1036.

At 1040, the base station 1004 may transmit the pre-equalized signal to the receiving device 1006. The receiving device 1006 may perform DL data decoding at 1042. Since the signal has been pre-equalized at the UE side, the receiving device 1006 may use a simplified scheme for decoding (e.g., a low complexity decoding 858), thereby reducing the power consumption on the receiving device 1006.

In some examples, at 1040, in addition to the pre-equalized signal, the UE 1002 may send another DL RS, which allows the receiving device 1006 to provide more recent channel information to the UE 1002. Upon receiving the DL RS at 1040, the XR device may repeat the steps similar to those for an earlier DL RS. For example, the receiving device 1006 may perform DL RS sampling and quantization (at 1044) on the new DL RS and transmit (at 1046) the DL RS sampling indication to the UE 1002.

At 1048, the UE 1002 may process the received data, such as the DL RS samples indication to obtain the more recent channel information.

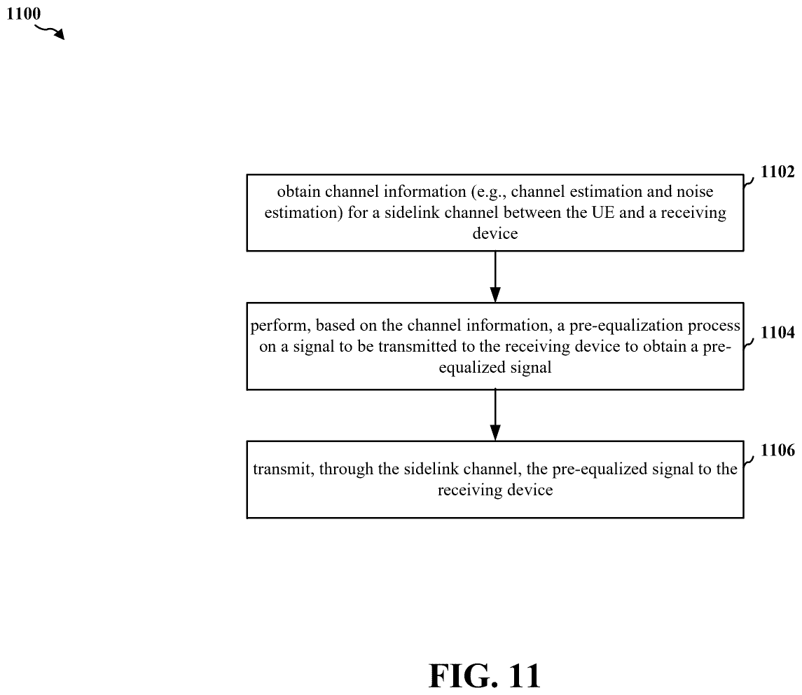

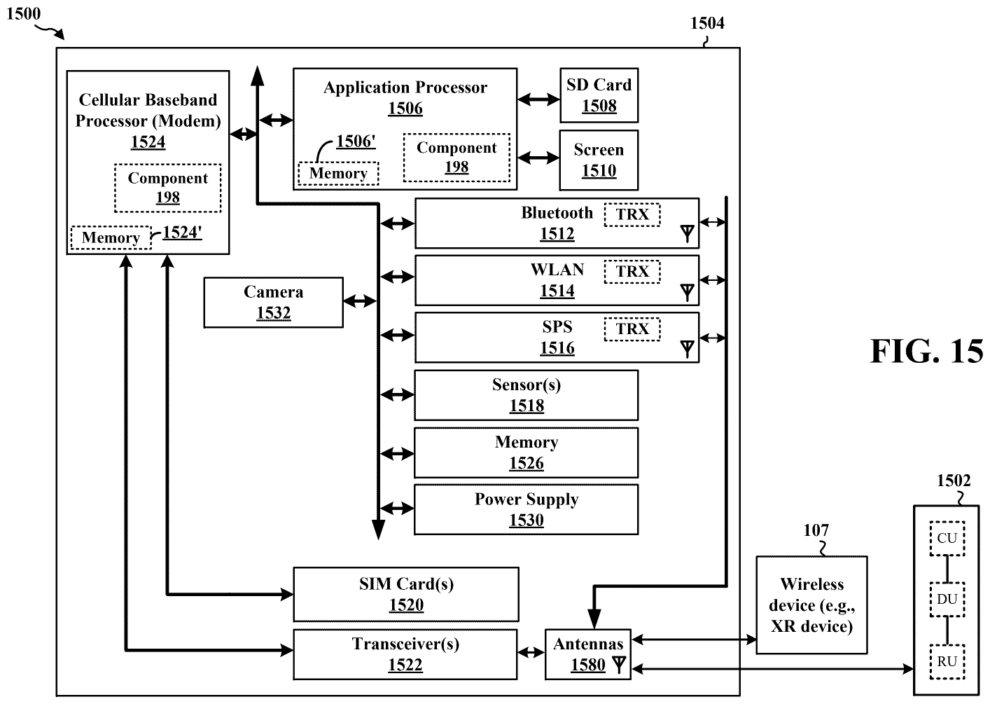

FIG. 11 is a flowchart 1100 illustrating methods of wireless communication at a UE in accordance with various aspects of the present disclosure. The method may be performed by a UE. The UE may be the UE 104, 350, 902, 1002, or the apparatus 1504 in the hardware implementation of FIG. 15. The methods allow the UE to perform the transmitter-side pre-equalization process on a signal before transmitting the pre-equalized signal to the XR device. The methods shift the equalization-related complexity from the XR device to the UE, thereby reducing the computation burden of the XR device and allowing a simpler and more portable/wearable hardware design for the XR devices.

As shown in FIG. 11, at 1102, the UE may obtain channel information for a sidelink channel between the UE and a receiving device. The receiving device may be an XR device, such as XR device 506, 904, or receiving device 1006. FIG. 9 and FIG. 10 illustrate various aspects of the steps in connection with flowchart 1100. For example, referring to FIG. 10, the UE 1002 may, at 1022, obtain channel information (e.g., DL RS samples indication) for a sidelink channel between the UE 1002 and a receiving device (e.g., 1006). Referring to FIG. 9, the UE 902 may obtain channel information (UL transmission 930) from XR device 904. The channel information may include channel estimation and noise estimation for the sidelink channel between the UE 1002 and the receiving device (e.g., 1006). In some examples, 1102 may be performed by the transmitter pre-equalization component 198.

At 1104, the UE may perform, based on the channel information, a pre-equalization process on a signal to be transmitted to the receiving device to obtain a pre-equalized signal. For example, referring to FIG. 10, the UE 1002 may perform, at 1036, based on the channel information, a pre-equalization process on a signal to be transmitted to the receiving device (1006) to obtain a pre-equalized signal. Referring to FIG. 9, the UE 902 may perform, at 950, a pre-equalization process on a signal to obtain a pre-equalized signal (at 960) for XR device 904. In some examples, 1104 may be performed by the transmitter pre-equalization component 198.

At 1106, the UE may transmit, through the sidelink channel, the pre-equalized signal to the receiving device. For example, referring to FIG. 10, the UE 1002 may transmit, at 1040, through the sidelink channel, the pre-equalized signal to the receiving device (1006). Referring to FIG. 9, the UE 902 may transmit, at 960, the pre-equalized signal to the receiving device (XR device 904). In some examples, 1106 may be performed by the transmitter pre-equalization component 198.

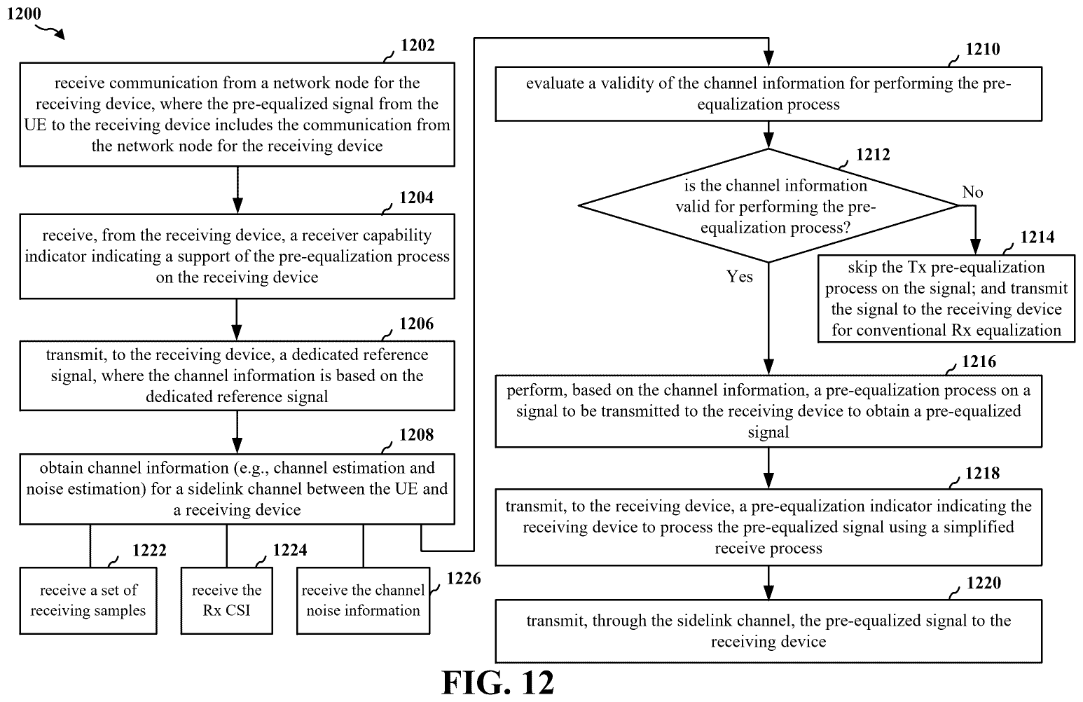

FIG. 12 is a flowchart 1200 illustrating methods of wireless communication at a UE in accordance with various aspects of the present disclosure. The method may be performed by a UE. The UE may be the UE 104, 350, 902, 1002, or the apparatus 1504 in the hardware implementation of FIG. 15. The methods allow the UE to perform the transmitter-side pre-equalization process on a signal before transmitting the pre-equalized signal to the XR device. The methods shift the equalization-related complexity from the XR device to the UE, thereby reducing the computation burden of the XR device and allowing a simpler and more portable/wearable hardware design for the XR devices.

As shown in FIG. 12, at 1208, the UE may obtain channel information for a sidelink channel between the UE and a receiving device. The receiving device may be an XR device, such as XR device 506, 904, or receiving device 1006. FIG. 9 and FIG. 10 illustrate various aspects of the steps in connection with flowchart 1200. For example, referring to FIG. 10, the UE 1002 may, at 1022, obtain channel information (e.g., DL RS samples indication) for a sidelink channel between the UE 1002 and a receiving device (1006). Referring to FIG. 9, the UE 902 may obtain channel information (UL transmission 930) from XR device 904. In some examples, the channel information may include the channel estimation (at 1018) and noise estimation (at 1020) for the sidelink channel between the UE 1002 and the receiving device (1006). In some examples, 1208 may be performed by the transmitter pre-equalization component 198.

At 1216, the UE may perform, based on the channel information, a pre-equalization process on a signal to be transmitted to the receiving device to obtain a pre-equalized signal. For example, referring to FIG. 10, the UE 1002 may perform, at 1036, based on the channel information, a pre-equalization process on a signal to be transmitted to the receiving device (1006) to obtain a pre-equalized signal. Referring to FIG. 9, the UE 902 may perform, at 950, a pre-equalization process on a signal to obtain a pre-equalized signal (at 960) for XR device 904. In some examples, 1216 may be performed by the transmitter pre-equalization component 198.

At 1220, the UE may transmit, through the sidelink channel, the pre-equalized signal to the receiving device. For example, referring to FIG. 10, the UE 1002 may transmit, at 1040, through the sidelink channel, the pre-equalized signal to the receiving device (1006). Referring to FIG. 9, the UE 902 may transmit, at 960, the pre-equalized signal to the receiving device (XR device 904). In some examples, 1220 may be performed by the transmitter pre-equalization component 198.

In some aspects, to transmit the pre-equalized signal (at 1220), the UE may transmit the pre-equalized signal via a set of OFDM symbols using an SBFD scheme or an FDD scheme. For example, referring to FIG. 10, the UE 1002 may transmit, at 1040, the pre-equalized signal via a set of OFDM symbols using an SBFD scheme or an FDD scheme.

In some aspects, at 1218, the UE may transmit, to the receiving device, a pre-equalization indicator indicating the receiving device to process the pre-equalized signal using a simplified receive process. The simplified receive process may skip the equalization process on the pre-equalized signal, and the pre-equalization indicator may further include a method indicator indicating the pre-equalization process and side information for the simplified receive process. For example, referring to FIG. 10, the UE 1002 may transmit, at 1038, to the receiving device (1006), a pre-equalization indicator. The pre-equalization indicator may indicate the receiving device (1006) to process the pre-equalized signal using a simplified receive process. The simplified receive process may skip the equalization process on the pre-equalized signal, and the pre-equalization indicator may further include a method indicator indicating the pre-equalization process and side information for the simplified receive process. In some examples, 1218 may be performed by the transmitter pre-equalization component 198.

In some aspects, the pre-equalization indicator may be transmitted (at 1218) via one or more of: an RRC configuration, DCI, or a MAC-CE. For example, referring to FIG. 10, the pre-equalization indicator may be transmitted (at 1038) via one or more of: an RRC configuration, DCI, or a MAC-CE.

In some aspects, at 1204, the UE may receive, from the receiving device, a receiver capability indicator indicating the support of the pre-equalization process on the receiving device. To perform the pre-equalization process (at 1216), the UE may perform, in response to the receiver capability indicator, the pre-equalization process. For example, referring to FIG. 10, the UE 1002 may receive, at 1012, a receiver capability indicator indicating the support of the pre-equalization process on the receiving device (1006). The UE 1002 may perform the pre-equalization process (at 1036) based on the receiver capability indicator. In some examples, 1204 may be performed by the transmitter pre-equalization component 198.

In some aspects, at 1206, the UE may transmit, to the receiving device, a dedicated reference signal. The channel information (at 1208) may be based on the dedicated reference signal. For example, referring to FIG. 10, the UE 1002 may transmit, at 1014, to the receiving device (1006), a dedicated reference signal (DL RS). Referring to FIG. 9, the UE 902 may transmit a dedicated reference signal (DL RS transmission 920) to the receiving device (1006). The channel information (e.g., UL transmission at 930) may be based on the dedicated reference signal. In some examples, 1206 may be performed by the transmitter pre-equalization component 198.

In some aspects, the channel information (at 1208) may include Rx CSI associated with the sidelink channel. For example, referring to FIG. 10, the channel information (the UE 1002 receives at 1022) may include Rx CSI associated with the sidelink channel.

In some aspects, to obtain the channel information (at 1208), the UE may, at 1222, receive from the receiving device a set of receiving samples based on the dedicated reference signal (transmitted at 1206); and identify, based on the set of receiving samples, the Rx CSI associated with the sidelink channel. For example, referring to FIG. 10, the UE 1002 may receive, at 1022, from the receiving device (1006), a set of receiving samples based on the dedicated reference signal. The UE 1002 may, at 1028, identify the Rx CSI associated with the sidelink channel based on the set of receiving samples. In some examples, 1222 may be performed by the transmitter pre-equalization component 198.

In some aspects, to obtain the channel information (at 1208), the UE may, at 1224, receive from the receiving device the Rx CSI associated with the sidelink channel. The Rx CSI may be based on the dedicated reference signal (at 1206). For example, referring to FIG. 10, the receiving device 1006 may estimate the Rx CSI at 1018, and transmit the Rx CSI to the UE 1002 at 1022. In some examples, 1224 may be performed by the transmitter pre-equalization component 198.

In some aspects, the channel information may further include channel noise information including a noise covariance matrix associated with the sidelink channel. For example, referring to FIG. 10, the channel information (UE 1002 receives at 1022) may further include channel noise information including a noise covariance matrix associated with the sidelink channel.

In some aspects, to obtain the channel information (at 1208), the UE may, at 1222, receive, from the receiving device, a set of receiving samples based on the dedicated reference signal; and identify, based on the set of receiving samples, the channel noise information. For example, referring to FIG. 10, the UE 1002 may receive, at 1022, a set of receiving samples based on the dedicated reference signal. The UE 1002 may identify the channel noise information (at 1030) based on the set of receiving samples.

In some aspects, to obtain the channel information (at 1208), the UE may, at 1226, receive, from the receiving device, the channel noise information. For example, referring to FIG. 10, the receiving device 1006 may estimate the channel noise information at 1020, and transmit the channel noise information to the UE 1002 at 1022. In some examples, 1226 may be performed by the transmitter pre-equalization component 198.

In some aspects, the pre-equalization process (at 1216) may include a linear pre-equalization process including one or more of: a ZF pre-equalization, or an MMSE pre-equalization. For example, referring to FIG. 10, the pre-equalization process (at 1036) may include a linear pre-equalization process including one or more of: a ZF pre-equalization, or an MMSE pre-equalization.

In some aspects, the pre-equalization process (at 1216) may include a non-linear pre-equalization process including one or more of: a THP-ZF pre-equalization, or a THP-MMSE pre-equalization. For example, referring to FIG. 10, the pre-equalization process (at 1036) may include a non-linear pre-equalization process including one or more of: the THP-ZF pre-equalization, or the THP-MMSE pre-equalization.

In some aspects, at 1210, the UE may evaluate the validity of the channel information for performing the pre-equalization process (at 1216). The UE may perform the pre-equalization process (at 1216) if the channel information is valid for performing the pre-equalization process. Based on whether the channel information is valid for performing the pre-equalization process (at 1212), the UE may, at 1214, skip the pre-equalization process on the signal on the UE side (if the channel information is invalid for performing the pre-equalization process) and transmit the signal to the receiving device for the receiving device to perform a regular equalization process on the received signal. For example, referring to FIG. 10, the UE 1002 may evaluate, at 1032, the validity of the channel information for performing the pre-equalization process (at 1036). The UE 1002 may perform the pre-equalization process (at 1036) if the channel information is valid for performing the pre-equalization process. If the channel information is not valid for performing the pre-equalization process at the UE 1002, the UE 1002 may skip the pre-equalization process on the signal on the UE 1002 and transmit, at 1034, the signal to the receiving device (1006) for the receiving device (1006) to perform a regular equalization process on the signal. In some examples, 1212 and 1214 may be performed by the transmitter pre-equalization component 198.

In some aspects, at 1202, the UE may receive communication from a network entity for the receiving device. The pre-equalized signal from the UE to the receiving device may include the communication from the network entity for the receiving device. The network entity may be a base station, or a component of a base station, in the access network of FIG. 1 or a core network component (e.g., base station 102, 310, 1004; or the network entity 1502 in the hardware implementation of FIG. 15). For example, referring to FIG. 10, the UE 1002 may receive communication from a network entity (base station 1004) for the receiving device (1006). The pre-equalized signal (at 1040) from the UE 1002 to the receiving device (XR device 1006) may include the communication from the network entity (base station 1004) for the receiving device (1006). In some examples, 1202 may be performed by the transmitter pre-equalization component 198.

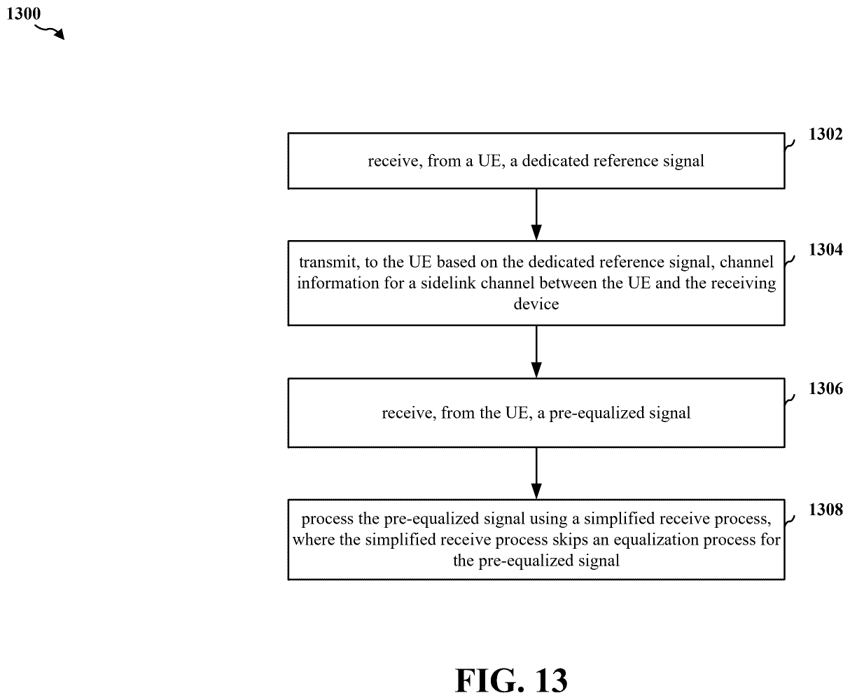

FIG. 13 is a flowchart 1300 illustrating methods of wireless communication at a receiving device in accordance with various aspects of the present disclosure. The method may be performed by a receiving device. The receiving device may be an XR device, such as XR device 506, 904, or receiving device 1006. The methods allow the UE to perform the transmitter-side pre-equalization process on a signal before transmitting the pre-equalized signal to the XR device. The methods shift the equalization-related complexity from the XR device to the UE, thereby reducing the computation burden of the XR device and allowing a simpler and more portable/wearable hardware design for the XR devices.

As shown in FIG. 13, at 1302, the receiving device may receive, from a UE, a dedicated reference signal. The UE may be the UE 104, 350, 902, 1002, or the apparatus 1504 in the hardware implementation of FIG. 15. FIG. 9 and FIG. 10 illustrate various aspects of the steps in connection with flowchart 1300. For example, referring to FIG. 10, the receiving device (1006) may receive, at 1014, from a UE 1002, a dedicated reference signal (DL RS). Referring to FIG. 9, the receiving device (XR device 904) may receive from a UE 902 a dedicated reference signal (e.g., DL RS transmission 920).

At 1304, the receiving device may transmit, to the UE based on the dedicated reference signal, channel information for a sidelink channel between the UE and the receiving device. For example, referring to FIG. 10, the receiving device (1006) may transmit, at 1022, to the UE 1002 based on the dedicated reference signal, channel information for a sidelink channel between the UE and the receiving device. Referring to FIG. 9, the receiving device (1006) may transmit to the UE 902 channel information (e.g., UL transmission 930).

At 1306, the receiving device may receive a pre-equalized signal from the UE. For example, referring to FIG. 9 and FIG. 10, the receiving device (XR device 904, or receiving device 1006) may receive a pre-equalized signal (960, 1040) from the UE 902, 1002.

At 1308, the receiving device may process the pre-equalized signal using a simplified receive process. The simplified receive process may skip an equalization process for the pre-equalized signal. For example, referring to FIG. 10, the receiving device (1006) may, at 1042, process the pre-equalized signal using a simplified receive process (e.g., a low complexity decoding 858).

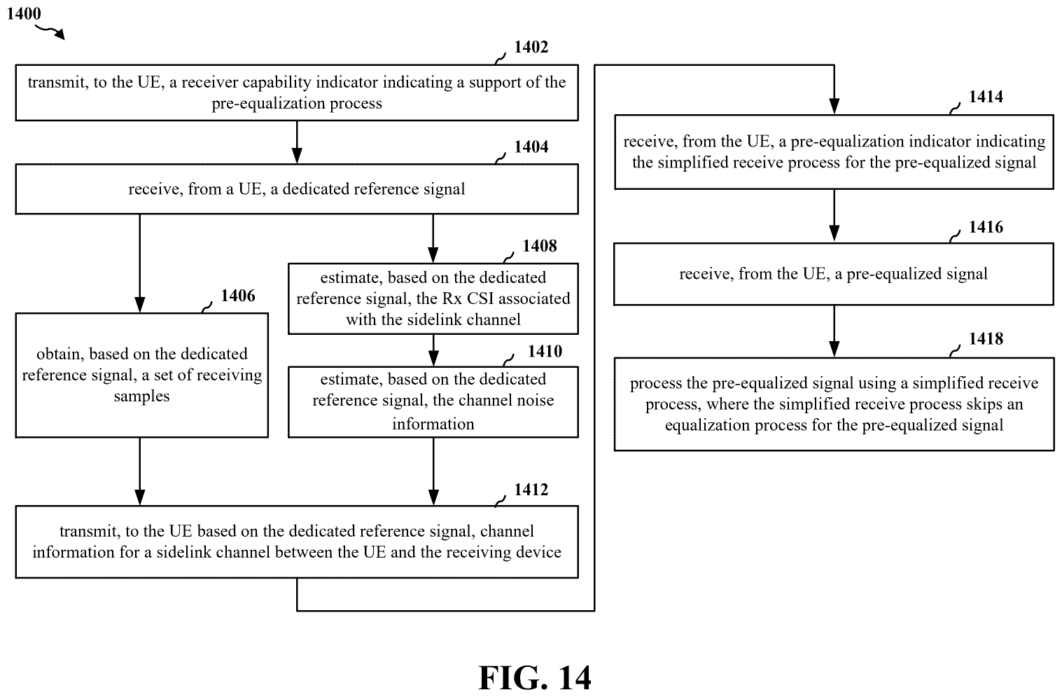

FIG. 14 is a flowchart 1400 illustrating methods of wireless communication at a receiving device in accordance with various aspects of the present disclosure. The method may be performed by a receiving device. The receiving device may be an XR device, such as XR device 506, 904, or receiving device 1006. The methods allow the UE to perform the transmitter-side pre-equalization process on a signal before transmitting the pre-equalized signal to the XR device. The methods shift the equalization-related complexity from the XR device to the UE, thereby reducing the computation burden of the XR device and allowing a simpler and more portable/wearable hardware design for the XR devices.

As shown in FIG. 14, at 1404, the network entity may receive, from a UE, a dedicated reference signal. The UE may be the UE 104, 350, 902, 1002, or the apparatus 1504 in the hardware implementation of FIG. 15. FIG. 9 and FIG. 10 illustrate various aspects of the steps in connection with flowchart 1400. For example, referring to FIG. 10, the receiving device (1006) may receive, at 1014, from a UE 1002, a dedicated reference signal (DL RS). Referring to FIG. 9, the receiving device (XR device 904) may receive from a UE 902 a dedicated reference signal (e.g., DL RS transmission 920).

At 1412, the receiving device may transmit, to the UE based on the dedicated reference signal, channel information for a sidelink channel between the UE and the receiving device. For example, referring to FIG. 10, the receiving device (1006) may transmit, at 1022, to the UE 1002 based on the dedicated reference signal, channel information for a sidelink channel between the UE and the receiving device. Referring to FIG. 9, the receiving device (1006) may transmit to the UE 902 channel information (e.g., UL transmission 930).

At 1416, the receiving device may receive a pre-equalized signal from the UE. For example, referring to FIG. 9 and FIG. 10, the receiving device (XR device 904, or receiving device 1006) may receive a pre-equalized signal (960, 1040) from the UE 902, 1002.

At 1418, the receiving device may process the pre-equalized signal using a simplified receive process. The simplified receive process may skip an equalization process for the pre-equalized signal. For example, referring to FIG. 10, the receiving device (1006) may, at 1042, process the pre-equalized signal using a simplified receive process (e.g., a low complexity decoding 858).

In some aspects, to receive the pre-equalized signal (at 1416), the receiving device may receive the pre-equalized signal via a set of OFDM symbols using an SBFD scheme or an FDD scheme. For example, referring to FIG. 10, the receiving device (1006) may receive, at 1040, the pre-equalized signal via a set of OFDM symbols using an SBFD scheme or an FDD scheme.

In some aspects, at 1414, the receiving device may receive, from the UE, a pre-equalization indicator indicating the simplified receive process for the pre-equalized signal. The pre-equalization indicator may further include a method indicator indicating a pre-equalization process performed on the pre-equalized signal and side information for the simplified receive process. For example, referring to FIG. 10, the receiving device (1006) may receive, at 1038, from the UE 1002, a pre-equalization indicator. The pre-equalization indicator may indicate the receiving device (1006) to process the pre-equalized signal using a simplified receive process. The simplified receive process may skip the equalization process on the pre-equalized signal, and the pre-equalization indicator may further include a method indicator indicating the pre-equalization process and side information for the simplified receive process.

In some aspects, the pre-equalization indicator may be received (at 1414) via one or more of: an RRC configuration, DCI, or a MAC-CE. For example, referring to FIG. 10, the pre-equalization indicator may be received (at 1038) via one or more of: an RRC configuration, DCI, or a MAC-CE.

In some aspects, at 1402, the receiving device may transmit, to the UE, a receiver capability indicator indicating a support of the pre-equalization process. For example, referring to FIG. 10, the receiving device (1006) may transmit, at 1012, a receiver capability indicator indicating the support of the pre-equalization process.

In some aspects, the channel information includes Rx CSI associated with the sidelink channel. For example, referring to FIG. 10, the channel information (the receiving device 1006 transmits at 1022) may include Rx CSI associated with the sidelink channel.

In some aspects, at 1406, the receiving device may obtain, based on the dedicated reference signal (at 1404), a set of receiving samples. To transmit the channel information (at 1412), the receiving device may transmit, to the UE, the set of receiving samples. For example, referring to FIG. 10, the receiving device (1006) may obtain a set of receiving samples at 1016, and transmit, at 1022, to the UE 1002, the set of receiving samples (DL RS samples indications).

In some aspects, at 1408, the receiving device may estimate, based on the dedicated reference signal, the Rx CSI associated with the sidelink channel. To transmit the channel information (at 1412), the receiving device may transmit, to the UE, the Rx CSI. For example, referring to FIG. 10, the receiving device (1006) may estimate, at 1018, the Rx CSI and transmit, at 1022, to the UE 1002, the Rx CSI.

In some aspects, the channel information may further include channel noise information including a noise covariance matrix associated with the sidelink channel. For example, referring to FIG. 10, the channel information (the receiving device 1006 transmits at 1022) may further include channel noise information including a noise covariance matrix (Rₙₙ) associated with the sidelink channel.

In some aspects, at 1410, the receiving device may estimate, based on the dedicated reference signal, the channel noise information. For example, referring to FIG. 10, the receiving device (receiving device 1006) may estimate, at 1020, the channel noise information.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to obtain channel information for a sidelink channel between the UE and a receiving device; perform, based on the channel information, a pre-equalization process on a signal to be transmitted to the receiving device to obtain a pre-equalized signal; and transmit, through the sidelink channel, the pre-equalized signal to the receiving device. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for obtaining channel information for a sidelink channel between the UE and a receiving device, means for performing, based on the channel information, a pre-equalization process on a signal to be transmitted to the receiving device to obtain a pre-equalized signal, and means for transmitting, through the sidelink channel, the pre-equalized signal to the receiving device. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

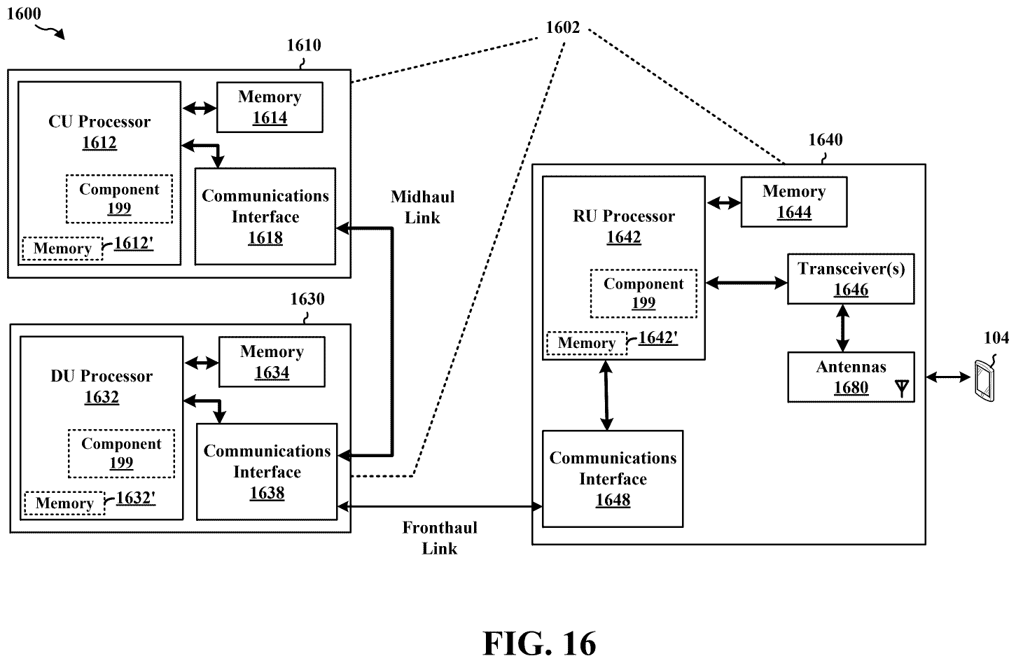

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to perform any of the aspects described in connection with the base station 1004 in FIG. 10. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for performing any of the aspects performed by the base station 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining channel information for a sidelink channel between the UE and a receiving device; performing, based on the channel information, a pre-equalization process on a signal to be transmitted to the receiving device to obtain a pre-equalized signal; and transmitting, through the sidelink channel, the pre-equalized signal to the receiving device. The methods allow the UE to perform the transmitter-side pre-equalization process on a signal before transmitting the pre-equalized signal to the XR device. The methods shift the equalization-related complexity from the XR device to the UE, thereby reducing the computation burden of the XR device and allowing a simpler and more portable/wearable hardware design for the XR devices.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes obtaining channel information for a sidelink channel between the UE and a receiving device; performing, based on the channel information, a pre-equalization process on a signal to be transmitted to the receiving device to obtain a pre-equalized signal; and transmitting, through the sidelink channel, the pre-equalized signal to the receiving device.

Aspect 2 is the method of aspect 1, wherein transmitting the pre-equalized signal comprises: transmitting the pre-equalized signal via a set of orthogonal frequency division multiplexing (OFDM) symbols using a sub-band full duplex (SBFD) scheme or a frequency division duplex (FDD) scheme.

Aspect 3 is the method of any of aspects 1 to 2, where the method further includes transmitting, to the receiving device, a pre-equalization indicator indicating the receiving device to process the pre-equalized signal using a simplified receive process, wherein the simplified receive process skips an equalization process on the pre-equalized signal, and the pre-equalization indicator further includes a method indicator indicating the pre-equalization process and side information for the simplified receive process.

Aspect 4 is the method of aspect 3, wherein the pre-equalization indicator is transmitted via one or more of: a radio resource control (RRC) configuration, downlink control information (DCI), or a medium access control (MAC)-control element (MAC-CE).

Aspect 5 is the method of any of aspects 1 to 3, where the method further includes receiving, from the receiving device, a receiver capability indicator indicating a support of the pre-equalization process on the receiving device, and wherein performing the pre-equalization process comprises: performing, in response to the receiver capability indicator, the pre-equalization process.

Aspect 6 is the method of any of aspects 1 to 2, where the method further includes transmitting, to the receiving device, a dedicated reference signal, wherein the channel information is based on the dedicated reference signal.

Aspect 7 is the method of aspect 6, wherein the channel information includes receive (Rx) channel state information (CSI) associated with the sidelink channel.

Aspect 8 is the method of aspect 7, wherein obtaining the channel information comprises: receiving, from the receiving device, a set of receiving samples based on the dedicated reference signal; and identifying, based on the set of receiving samples, the Rx CSI associated with the sidelink channel.

Aspect 9 is the method of aspect 7, wherein obtaining the channel information comprises: receiving, from the receiving device, the Rx CSI associated with the sidelink channel, wherein the Rx CSI is based on the dedicated reference signal.

Aspect 10 is the method of aspect 7, wherein the channel information further includes channel noise information comprising a noise covariance matrix associated with the sidelink channel.

Aspect 11 is the method of aspect 10, wherein obtaining the channel information further comprises: receiving, from the receiving device, a set of receiving samples based on the dedicated reference signal; and identifying, based on the set of receiving samples, the channel noise information.

Aspect 12 is the method of aspect 10, wherein obtaining the channel information further comprises: receiving, from the receiving device, the channel noise information.

Aspect 13 is the method of any of aspects 1 to 2, wherein the pre-equalization process includes a linear pre-equalization process comprising one or more of: a zero-forcing (ZF) pre-equalization, or a minimum mean square error (MMSE) pre-equalization.

Aspect 14 is the method of any of aspects 1 to 2, wherein the pre-equalization process includes a non-linear pre-equalization process comprising one or more of: a Tomlinson-Harashima (THP) zero-forcing (THP-ZF) pre-equalization, or a THP-minimum mean square error (THP-MMSE) pre-equalization.

Aspect 15 is the method of any of aspects 1 to 2, where the method further includes evaluating a validity of the channel information for performing the pre-equalization process, wherein performing the pre-equalization process comprises: performing, in response the channel information being valid for performing the pre-equalization process, the pre-equalization process, and wherein the method further comprises: skipping, in response to the channel information being invalid for performing the pre-equalization process, the pre-equalization process on the signal; and transmitting, in response to the channel information being invalid for performing the pre-equalization process, the signal to the receiving device for the receiving device to perform a regular equalization process on the signal.

Aspect 16 is the method of any of aspects 1 to 15, where the method further includes receiving communication from a network entity for the receiving device, wherein the pre-equalized signal from the UE to the receiving device includes the communication from the network entity for the receiving device.

Aspect 17 is an apparatus for wireless communication at a UE, comprising: a processing system that includes processor circuitry and memory circuitry that stores code and is coupled with the processor circuitry, the processing system configured to cause the UE to perform the method of one or more of Aspects 1-16.

Aspect 18 is an apparatus for wireless communication at a UE, comprising: at least one memory; and at least one processor coupled to the at least one memory and, where the at least one processor, individually or in any combination, is configured to perform the method of any of aspects 1-16.

Aspect 19 is the apparatus for wireless communication at a UE, comprising means for performing each step in the method of any of aspects 1-16.

Aspect 20 is an apparatus of any of aspects 17-19, further comprising a transceiver configured to receive or to transmit in association with the method of any of aspects 1-16.

Aspect 21 is a computer-readable medium (e.g., a non-transitory computer-readable medium) storing computer executable code at a UE, the code when executed by at least one processor causes the at least one processor to, individually or in any combination, perform the method of any of aspects 1-16.

Aspect 22 is a method of wireless communication at a receiving device. The method includes receiving, from a user equipment (UE), a dedicated reference signal; transmitting, to the UE based on the dedicated reference signal, channel information for a sidelink channel between the UE and the receiving device; receiving, from the UE, a pre-equalized signal; and processing the pre-equalized signal using a simplified receive process, wherein the simplified receive process skips an equalization process for the pre-equalized signal.

Aspect 23 is the method of aspect 22, wherein receiving the pre-equalized signal comprises: receiving the pre-equalized signal via a set of orthogonal frequency division multiplexing (OFDM) symbols using a sub-band full duplex (SBFD) scheme or a frequency division duplex (FDD) scheme.

Aspect 24 is the method of any of aspects 22 to 23, where the method further includes receiving, from the UE, a pre-equalization indicator indicating the simplified receive process for the pre-equalized signal, wherein the pre-equalization indicator further includes a method indicator indicating a pre-equalization process performed on the pre-equalized signal and side information for the simplified receive process.

Aspect 25 is the method of aspect 24, wherein the pre-equalization indicator is received via one or more of: a radio resource control (RRC) configuration, downlink control information (DCI), or a medium access control (MAC)-control element (MAC-CE).

Aspect 26 is the method of aspect 24, where the method further includes transmitting, to the UE, a receiver capability indicator indicating a support of the pre-equalization process.

Aspect 27 is the method of aspect 23, wherein the channel information includes receive (Rx) channel state information (CSI) associated with the sidelink channel.

Aspect 28 is the method of aspect 27, where the method further includes obtaining, based on the dedicated reference signal, a set of receiving samples, wherein transmitting the channel information comprises: transmitting, to the UE, the set of receiving samples.

Aspect 29 is the method of aspect 27, where the method further includes estimating, based on the dedicated reference signal, the Rx CSI associated with the sidelink channel, wherein transmitting the channel information comprises: transmitting, to the UE, the Rx CSI.

Aspect 30 is the method of aspect 27, wherein the channel information further includes channel noise information comprising a noise covariance matrix associated with the sidelink channel.

Aspect 31 is the method of aspect 30, where the method further includes estimating, based on the dedicated reference signal, the channel noise information.

Aspect 32 is an apparatus for wireless communication at a receiving device, comprising: a processing system that includes processor circuitry and memory circuitry that stores code and is coupled with the processor circuitry, the processing system configured to cause the receiving device to perform the method of one or more of aspects 22-31.

Aspect 33 is an apparatus for wireless communication at a receiving device, comprising: at least one memory; and at least one processor coupled to the at least one memory and, where the at least one processor, individually or in any combination, is configured to perform the method of any of aspects 22-31.

Aspect 34 is the apparatus for wireless communication at a receiving device, comprising means for performing each step in the method of any of aspects 22-31.

Aspect 35 is an apparatus of any of aspects 32-34, further comprising a transceiver configured to receive or to transmit in association with the method of any of aspects 22-31.

Aspect 36 is a computer-readable medium (e.g., a non-transitory computer-readable medium) storing computer executable code at a receiving device, the code when executed by at least one processor causes the at least one processor to, individually or in any combination, perform the method of any of aspects 22-31.

What is claimed is:

1. An apparatus of wireless communication at a user equipment (UE), comprising:
at least one memory; and
at least one processor coupled to the at least one memory and, based at least in part on information stored in the at least one memory, the at least one processor, individually or in any combination, is configured to cause the UE to:
obtain channel information for a sidelink channel between the UE and a receiving device;
perform, based on the channel information, a pre-equalization process on a signal to be transmitted to the receiving device to obtain a pre-equalized signal; and
transmit, through the sidelink channel, the pre-equalized signal to the receiving device.

2. The apparatus of claim 1, further comprising a transceiver coupled to the at least one processor, wherein to obtain the channel information, the at least one processor, individually or in any combination, is configured to obtain the channel information via the transceiver, and wherein to transmit the pre-equalized signal, the at least one processor, individually or in combination, is configured to cause the UE to:
transmit the pre-equalized signal via a set of orthogonal frequency division multiplexing (OFDM) symbols using a sub-band full duplex (SBFD) scheme or a frequency division duplex (FDD) scheme.

3. The apparatus of claim 2, wherein the at least one processor, individually or in combination, is further configured to cause the UE to:
transmit, to the receiving device, a pre-equalization indicator indicating the receiving device to process the pre-equalized signal using a simplified receive process, wherein the simplified receive process skips an equalization process on the pre-equalized signal, and the pre-equalization indicator further includes a method indicator indicating the pre-equalization process and side information for the simplified receive process.

4. The apparatus of claim 3, wherein the pre-equalization indicator is transmitted via one or more of:
a radio resource control (RRC) configuration,
downlink control information (DCI), or
a medium access control (MAC)-control element (MAC-CE).

5. The apparatus of claim 3, wherein the at least one processor, individually or in combination, is further configured to cause the UE to:
receive, from the receiving device, a receiver capability indicator indicating a support of the pre-equalization process on the receiving device, and wherein to perform the pre-equalization process, the at least one processor, individually or in combination, is configured to cause the UE to:
perform, in response to the receiver capability indicator, the pre-equalization process.

6. The apparatus of claim 2, wherein the at least one processor, individually or in combination, is configured to cause the UE to:
transmit, to the receiving device, a dedicated reference signal, wherein the channel information is based on the dedicated reference signal.

7. The apparatus of claim 6, wherein the channel information includes receive (Rx) channel state information (CSI) associated with the sidelink channel.

8. The apparatus of claim 7, wherein to obtain the channel information, the at least one processor, individually or in combination, is configured to cause the UE to:
receive, from the receiving device, a set of receiving samples based on the dedicated reference signal; and
identify, based on the set of receiving samples, the Rx CSI associated with the sidelink channel.

9. The apparatus of claim 7, wherein to obtain the channel information, the at least one processor, individually or in combination, is configured to cause the UE to:
receive, from the receiving device, the Rx CSI associated with the sidelink channel, wherein the Rx CSI is based on the dedicated reference signal.

10. The apparatus of claim 7, wherein the channel information further includes channel noise information comprising a noise covariance matrix associated with the sidelink channel.

11. The apparatus of claim 10, wherein to obtain the channel information, the at least one processor, individually or in combination, is further configured to cause the UE to:
receive, from the receiving device, a set of receiving samples based on the dedicated reference signal; and
identify, based on the set of receiving samples, the channel noise information.

12. The apparatus of claim 10, wherein to obtain the channel information, the at least one processor, individually or in combination, is further configured to cause the UE to:
receive, from the receiving device, the channel noise information.

13. The apparatus of claim 2, wherein the pre-equalization process includes a linear pre-equalization process comprising one or more of:
a zero-forcing (ZF) pre-equalization, or
a minimum mean square error (MMSE) pre-equalization.

14. The apparatus of claim 2, wherein the pre-equalization process includes a non-linear pre-equalization process comprising one or more of:
a Tomlinson-Harashima (THP) zero-forcing (THP-ZF) pre-equalization, or
a THP-minimum mean square error (THP-MMSE) pre-equalization.

15. The apparatus of claim 2, wherein the at least one processor, individually or in combination, is further configured to cause the UE to:
evaluate a validity of the channel information for performing the pre-equalization process, wherein to perform the pre-equalization process, the at least one processor, individually or in combination, is configured to cause the UE to:
perform, in response the channel information being valid for performing the pre-equalization process, the pre-equalization process, and wherein the at least one processor, individually or in combination, is further configured to cause the UE to:
skip, in response to the channel information being invalid for performing the pre-equalization process, the pre-equalization process on the signal; and
transmit, in response to the channel information being invalid for performing the pre-equalization process, the signal to the receiving device for the receiving device to perform a regular equalization process on the signal.

16. The apparatus of claim 1, wherein the at least one processor, individually or in combination, further is configured to cause the UE to:
receive communication from a network entity for the receiving device, wherein the pre-equalized signal from the UE to the receiving device includes the communication from the network entity for the receiving device.

17. An apparatus of wireless communication at a receiving device, comprising:
at least one memory; and
at least one processor coupled to the at least one memory and, based at least in part on information stored in the at least one memory, the at least one processor, individually or in any combination, is configured to cause the receiving device to:
receive, from a user equipment (UE), a dedicated reference signal;
transmit, to the UE based on the dedicated reference signal, channel information for a sidelink channel between the UE and the receiving device;
receive, from the UE, a pre-equalized signal; and
process the pre-equalized signal using a simplified receive process, wherein the simplified receive process skips an equalization process for the pre-equalized signal.

18. The apparatus of claim 17, further comprising a transceiver coupled to the at least one processor, wherein to receive the dedicated reference signal, the at least one processor, individually or in any combination, is configured to receive the dedicated reference signal via the transceiver, and wherein to receive the pre-equalized signal, the at least one processor, individually or in combination, is configured to cause the receiving device to:
receive the pre-equalized signal via a set of orthogonal frequency division multiplexing (OFDM) symbols using a sub-band full duplex (SBFD) scheme or a frequency division duplex (FDD) scheme.

19. The apparatus of claim 18, wherein the at least one processor, individually or in combination, is configured to cause the receiving device to:
receive, from the UE, a pre-equalization indicator indicating the simplified receive process for the pre-equalized signal, wherein the pre-equalization indicator further includes a method indicator indicating a pre-equalization process performed on the pre-equalized signal and side information for the simplified receive process.

20. The apparatus of claim 19, wherein the pre-equalization indicator is received via one or more of:
a radio resource control (RRC) configuration,
downlink control information (DCI), or
a medium access control (MAC)-control element (MAC-CE).

21. The apparatus of claim 19, wherein the at least one processor, individually or in combination, is further configured to cause the receiving device to:
transmit, to the UE, a receiver capability indicator indicating a support of the pre-equalization process.

22. The apparatus of claim 18, wherein the channel information includes receive (Rx) channel state information (CSI) associated with the sidelink channel.

23. The apparatus of claim 22, wherein the at least one processor, individually or in combination, is further configured to cause the receiving device to:
obtain, based on the dedicated reference signal, a set of receiving samples, wherein to transmit the channel information, the at least one processor, individually or in combination, is configured to cause the receiving device to:
transmit, to the UE, the set of receiving samples.

24. The apparatus of claim 22, wherein the at least one processor, individually or in combination, is configured to cause the receiving device to:
estimate, based on the dedicated reference signal, the Rx CSI associated with the sidelink channel, wherein to transmit the channel information, the at least one processor, individually or in combination, is configured to cause the receiving device to:
transmit, to the UE, the Rx CSI.

25. The apparatus of claim 22, wherein the channel information further includes channel noise information comprising a noise covariance matrix associated with the sidelink channel.

26. The apparatus of claim 25, wherein the at least one processor, individually or in combination, is further configured to cause the receiving device to:
estimate, based on the dedicated reference signal, the channel noise information.

27. A method of wireless communication at a user equipment (UE), comprising:
obtaining channel information for a sidelink channel between the UE and a receiving device;
performing, based on the channel information, a pre-equalization process on a signal to be transmitted to the receiving device to obtain a pre-equalized signal; and
transmitting, through the sidelink channel, the pre-equalized signal to the receiving device.

28. The method of claim 27, wherein transmitting the pre-equalized signal comprises:
transmitting the pre-equalized signal via a set of orthogonal frequency division multiplexing (OFDM) symbols using a sub-band full duplex (SBFD) scheme or a frequency division duplex (FDD) scheme.

29. A method of wireless communication at a receiving device, comprising:
receiving, from a user equipment (UE), a dedicated reference signal;
transmitting, to the UE based on the dedicated reference signal, channel information for a sidelink channel between the UE and the receiving device;
receiving, from the UE, a pre-equalized signal; and
processing the pre-equalized signal using a simplified receive process, wherein the simplified receive process skips an equalization process for the pre-equalized signal.

30. The method of claim 29, wherein receiving the pre-equalized signal comprises:
receiving the pre-equalized signal via a set of orthogonal frequency division multiplexing (OFDM) symbols using a sub-band full duplex (SBFD) scheme or a frequency division duplex (FDD) scheme.
